(19) United States
(12) Patent Application Publication
(10) Pub. No.: US 2026/0308292 A1
(43) Pub. Date: Oct. 8, 2026

(54) HIGH DART IMPACT AND TEAR FILMS FROM TITANIUM BASED PREPOLYMER CATALYZED POLYETHYLENES

(71) Applicant: Formosa Plastics Corporation, USA, Livingston, NJ (US)

(72) Inventors: Guangxu XU, Port Lavaca, TX (US); Zhiming WANG, Port Lavaca, TX (US)

(73) Assignee: Formosa Plastics Corporation, USA, Livingston, NJ (US)

(21) Appl. No.: 19/172,314

(22) Filed: Apr. 7, 2025

(51) Int. Cl. C08F 210/16; B29C 39/00; B29C 49/00; B29C 49/04; B29K 23/00; B29L 7/00; C08F 2/34; C08F 4/02; C08F 4/64

(52) U.S. Cl. CPC C08F 210/16; B29C 39/003; B29C 49/0005; B29C 49/04; C08F 2/34; C08F 4/022; C08F 4/64; B29K 2023/08; B29K 2995/0081; B29K 2995/0089; B29L 2007/008

(57) ABSTRACT

A polyethylene film with enhanced physical and mechanical properties, along with a method for its production, is presented. Notably, the film exhibits a 2% secant modulus exceeding 20,000 psi, dart impact resistance greater than 500 g/mil, and machine direction (MD) tear strength above 500 g/mil. The production method involves reacting ethylene with a comonomer in the presence of a Ziegler-Natta (titanium) base prepolymer at temperatures ranging from 75° C. to 95° C. The process operates under an ethylene partial pressure between 90 psia and 125 psia, with a comonomer-to-ethylene ratio of 0.08 to 0.15, enabling the formation of an ethylene-based polymer without the need for additional cocatalysts or antistatic agents in the gas phase polymerization process.

### BACKGROUND OF THE INVENTION

The present invention relates to films that exhibit an excellent balance of physical properties. These films are produced by polymerizing ethylene with a comonomer in the presence of a Ziegler-Natta titanium-based prepolymerized catalyst (referred to as “titanium-based prepolymer or prepolymer”), which has a broad composition distribution and a narrow molecular weight distribution. The present invention further encompasses the method for producing the titanium-based prepolymer, the process for manufacturing polyethylene using the titanium-based prepolymer, and the films derived from such polyethylene.

Various types of polyethylene are known in the art, with ethylene copolymers such as linear low-density polyethylene (LLDPE) being particularly significant in industrial film applications. LLDPE is produced through the copolymerization of ethylene and α-olefins using Ziegler-Natta or metallocene catalysts, and its importance in this field continues to grow.

Key properties of films include tear strength (e.g., MD tear) and impact resistance (e.g., Dart impact). These properties are typically inversely related, such that an improvement in one of them is accompanied by a deterioration in the other. Another critical factor is the processability of the resin, particularly its extrudability and bubble stability. Thus, the film industry has been focused on developing polyethylene film that offer impact resistance comparable to or better than that of m-LLDPE resins, while maintaining the superior stiffness, tear resistance, and processability characteristic of films made from Ziegler-Natta LLDPE (ZN-LLDPE) resins.

Conventional Ziegler-Natta catalyzed polyethylene copolymers, such as linear low-density polyethylene (LLDPE), typically exhibit both a broad molecular weight distribution and a heterogeneous comonomer distribution. As such, comonomers tend to be incorporated primarily into the low-molecular-weight polymer chains, while the high-molecular-weight chains contain little to no comonomer content. This leads to a heterogeneous distribution of short-chain branching (SCB) across polymer chains of varying molecular weights. The lack of compositional uniformity is associated with several drawbacks, including organoleptic issues caused by the presence of low-molecular-weight fractions, as well as suboptimal impact strength, which is thought to result from the crystallinity of the homopolymer component. As a consequence, while conventional Ziegler-Natta-catalyzed LLDPE films demonstrate favorable processability, stiffness, and tear strength-evidenced by metrics such as extruder pressure, motor load, 2% secant modulus, and Elmendorf tear strength-they often exhibit poor toughness, as indicated by low dart drop impact strength, puncture resistance, and clarity.

Metallocene or single-site catalysts typically produce resins with a narrow composition distribution, where comonomers are evenly distributed across polymer chains of varying molecular weights. Metallocene or single-site catalyzed LLDPE (mLLDPE), characterized by both a narrow composition and molecular weight distribution, is known to produce tough films with high dart impact strength, excellent puncture resistance, and superior optical properties. However, this type of LLDPE can present challenges in processability and exhibit lower film stiffness and tear strength (e.g., MD tear strength). Additionally, incorporating metallocene or single-site catalysts into existing polymerization processes often requires significant modifications and substantial capital investment. This is largely due to the solubility of organometallic compounds and cocatalysts, such as methylaluminoxane (MAO), which necessitate costly immobilization on inorganic supports to achieve good operability while maintaining acceptable catalyst activity in supported metallocene systems.

As such, new catalyst technologies and processes have garnered significant interest in the industry for the development of an “omnipotent” polyethylene resin-one that combines the best characteristics of both Ziegler-Natta (Z-N) and metallocene catalysis. The ideal resin would offer Z-N LLDPE processability while producing a film with a balance of metallocene-like toughness and Ziegler-Natta-like stiffness and tear strength.

Improving the toughness of films, particularly machine direction (MD) tensile strength, can be achieved by increasing the orientation in the MD during the film blowing process.

However, conventional knowledge in the polyethylene film industry suggests that enhancing MD orientation typically results in a trade-off: while MD tensile strength improves, other properties, such as MD tear strength, tend to degrade. Specifically, the MD Elmendorf tear strength has been shown to be inversely related to the drawdown ratio and MD shrinkage. At higher MD extension rates, a greater number of polymer chains align along the MD axis before crystallization begins, which negatively impacts MD tear performance. This trade-off between tensile strength and tear resistance presents a challenge in optimizing polyethylene films for both toughness and tear resistance.

Films made from bimodal polyethylene compositions—comprising both a low molecular weight (LMW) component and a high molecular weight (HMW) component—are well-known for their desirable properties. The lower molecular weight fraction enhances the extrudability of the resin, while the higher molecular weight fraction contributes to improved mechanical properties and melt strength. However, films produced from bimodal resins can exhibit a less desirable appearance due to the presence of gels and “white spots.” These defects are often indicative of lower homogeneity in the final resin or greater interparticle heterogeneity, particularly in terms of the ratio of LMW to HMW within the polymer particles. This can result from the multistage continuous processing conditions, where variations in residence time distribution affect the blending of the components.

U.S. Pat. No. 5,382,630, the disclosure of which is incorporated herein by reference, describes multimodal polyethylene blends in which tear strength can be controlled. Specifically, the patent details linear ethylene interpolymer blends formed from components that may have the same molecular weight but different comonomer contents, the same comonomer contents but different molecular weights, or comonomer contents that increase with molecular weight. However, despite these advancements, the improvements in both dart impact strength and MD tear or Elmendorf MD/TD tear ratios remain significantly below the expected values.

U.S. Pat. No. 5,514,455, which is incorporated herein by reference, discloses that reducing the gauge of polyethylene films leads to an increase in tear values. This patent utilizes a titanium-magnesium catalyst for polyethylene production, reporting Elmendorf tear ratios in the machine direction (MD) to transverse direction (TD) within a range of 0.1-0.3. In inventive examples, MD tear strength and dart impact strength of the film are both below 300 g/mil.

U.S. Pat. Nos. 6,242,545 and 6,248,845, which are incorporated herein by reference, describe polyethylene resins with either a broad composition distribution and narrow molecular weight distribution, or a broad composition distribution and relatively broad molecular weight distribution. These patents demonstrate improved MD tear strength in cast film, but no significant improvement in MD tear strength for blown film.

U.S. Pat. Nos. 5,139,986 and 5,470,812, which are incorporated herein by reference, describe methods to improve the balance of tear and dart impact properties. These patents utilize silica-supported Ziegler-Natta catalysts prepared by impregnating silica with a solution containing magnesium alkyl, TiCl₄, THF, or a silane compound such as tetraethyl orthosilicate. The chemical and physical impregnation process significantly impact catalyst performance. When combined with AlMe₃ as a cocatalyst, these catalysts were the first to produce “super-hexene” grade LLDPE, which demonstrated improved dart impact strength and reduced hexane extractables. However, even with these advanced Ziegler-Natta catalysts, the dart impact strength of the resulting film remains below 400 g/mil, falling short of the performance achieved by metallocene-catalyzed LLDPE films.

U.S. Pat. Nos. 6,140,264, 6,825,293, and 7,211,535, also incorporated herein by reference, disclose a modified impregnated silica-based Ziegler-Natta catalyst. In this approach, silica is first pacified by treatment with an aluminum alkyl. Magnesium chloride is then deposited on the treated silica by chlorinating a magnesium alkyl compound. An electron donor such as THF, a titanium compound, and a second aluminum compound (known as “split Al addition”) are subsequently added. Adjusting the order of these additions following the magnesium alkyl step allows production of “super-hexene” grade LLDPE without requiring AlMe₃ as a cocatalyst, using AlEt₃ instead. Cocatalyst concentration is also crucial for determining the final film's mechanical properties, including dart impact strength. Although dart impact strength is improved, MD tear values remain under 400 g/mil in inventive examples.

U.S. Pat. Nos. 6,291,613 and 7,652,113, which are incorporated herein by reference, disclose a process for gas-phase polymerization of olefins to produce novel polyethylene, along with films and articles derived therefrom. The process involves contacting at least one olefin with a prepolymerized Ziegler-Natta type catalyst in the presence of specific compounds, such as dinitrogen monoxide (N₂O) or cyanogen (C₂N₂), along with an external electron donor (e.g., tetrahydrofuran (THF)) and a secondary cocatalyst, trimethylaluminum (TMA). This combination, applied during gas-phase polymerization, results in an olefin homopolymer or interpolymer with a narrower molecular weight distribution and reduced hexane extractables compared to products made without N₂O or C₂N₂. U.S. Pat. Nos. 6,291,613 and 7,652,113 show a significant improvement in film dart impact strength, comparable to that of metallocene-catalyzed LLDPE. However, these documents do not disclose any improvement in machine direction (MD) tear, nor do these documents address Elmendorf MD/TD tear ratios. Additionally, the process is complex due to the use of multiple components (TMA/N₂O/THF/CHCl₃ or TMA/C₂N₂/THF/CHCl₃), which must be injected directly and individually into the gas phase during polymerization. This complexity necessitates additional process modifications, increases the variation to control product quality consistency, and still demonstrates lower polyethylene productivity.

In other prior art, titanium-based catalysts have been shown to produce polyethylene with higher machine direction (MD) tear strength but lower dart impact resistance, while zirconium-based catalysts yield polyethylene with higher dart impact resistance but lower MD tear strength. One reported solution is a supported hafnium-based metallocene catalyst, which achieves a balance between high MD tear strength and high dart impact resistance, as detailed in U.S. Pat. Nos. 6,248,845; 7,381,783; 7,989,564; and 7,179,876, all of which are incorporated by reference. This hafnium-based metallocene catalyst, supported on SiO₂/MAO, produces a polyethylene film with a 1% secant modulus of over 25,000 psi, dart impact resistance above 500 g/mil, and MD tear strength exceeding 500 g/mil. In this system, the concentration of trimethylaluminum (TMA) in the methylaluminoxane (MAO) solution is critical for controlling the chemical composition of polyethylene copolymers. However, integrating metallocene catalysts into existing polymerization processes poses several challenges. These catalysts are highly sensitive to gas impurities, which necessitates significant process modifications and additional capital investment. The high costs of metallocene and methylaluminoxane (MAO) components further complicate their adoption. Additionally, the solubility of organometallic compounds and cocatalysts, such as MAO, requires expensive immobilization on inorganic supports to ensure process operability and maintain adequate catalyst activity in supported metallocene systems.

The present Assignee's prior patents, including U.S. Pat. Nos. 7,618,913; 8,993,693; 9,487,608; 10,344,105; and 11,952,445, which are all incorporated by reference herein in their entireties, describe a supported titanium-based Ziegler-Natta catalyst system that incorporates a nitrogen-based electron donor for producing distinctive ethylene copolymers. Specifically, U.S. Pat. Nos. 7,618,913; 8,993,693; and 9,487,608 disclose a catalyst component activated with a conventional trialkylaluminum cocatalyst, producing ethylene-based polymers or copolymers (LLDPE) with a narrower molecular weight distribution, more uniform comonomer composition distribution, and improved mechanical properties such as dart impact and tear strength. However, the production efficiency of catalyst, reactor operability (e.g. reactor static), polymer morphology, and film performance (including balance between MD/TD and dart impact) need to be further improved.

Later, using the same supported titanium-based Ziegler-Natta catalyst system with a nitrogen-based electron donor, U.S. Pat. Nos. 10,344,105 and 11,952,445 disclose a catalyst component activated with a mixture of MAO and trialkylaluminum as a cocatalyst. This activation approach efficiently produces ethylene-based polymers or copolymers (LLDPE) featuring sporadic long-chain branching and a reversed comonomer composition distribution or short-chain branching distribution (SCBD) in the high molecular weight fractions. However, the use of MAO in the process increases costs and complicates operations due to the challenges associated with handling MAO and operability. The use of a mixture of MAO and trialkylaluminum as a cocatalyst has the potential to reduce MD tear strength while enhancing the dart impact and puncture resistance of films.

Therefore, there is a need for a polyolefin, specifically a blown polyethylene film, that offers high machine direction tear (MD tear), high transverse direction tear (TD tear), and high dart drop impact resistance, produced efficiently in existing gas-phase processes with improved operability. This film should be easily manufactured using a low-cost, high-performance titanium-based Ziegler-Natta catalyst within the existing gas-phase polymerization process. Ideally, this catalyst system would enable the production of polyethylene films that combine the properties of both conventional ZN-made LLDPE and metallocene-made mLLDPE. More specifically, it would be highly desirable to achieve polyethylene resins with ZN-LLDPE processability and tear strength equal to or better than ZN-LLDPE, along with dart impact strength and optical properties that are comparable to or exceed those of mLLDPE.

### SUMMARY OF THE INVENTION

We have now identified a range of polymer compositions capable of producing films with an optimized balance of mechanical properties, notably enhanced tear strength and impact resistance, along with excellent extrudability, melt strength, tensile strength, and barrier properties. This innovation provides a polyethylene film with improved physical and mechanical characteristics, along with a method for its production.

In one aspect of the present invention, the film exhibits a 2% secant modulus exceeding about 20,000 psi, a dart impact resistance greater than about 500 g/mil, and a machine direction (MD) tear strength over about 500 g/mil. In another aspect of the present invention, the film comprises an ethylene-based polymer produced using a titanium-based prepolymer in a gas-phase reactor operated at temperatures between 75° C. and 95° C., with an ethylene partial pressure ranging from 90 to 110 psia, without the addition of cocatalysts or antistatic agents during gas-phase polymerization.

In yet another aspect of the present invention, a film is provided by extruding an ethylene-based polymer synthesized with a titanium-based prepolymer in a gas-phase reactor operated at temperatures between 85° C. and 105° C. and an ethylene partial pressure of 90 to 130 psia, without the addition of cocatalysts or antistatic agents during gas-phase polymerization. The resulting film features a 2% secant modulus exceeding about 20,000 psi, a dart impact resistance greater than about 500 g/mil, and an MD tear strength over about 500 g/mil.

In yet another aspect of the present invention, a film is provided by extruding an ethylene-based polymer comprising two major fractions. The one soluble fraction, referred to as the “35° C. soluble fraction,” exhibits a peak elution temperature between 25° C. and 35° C., while another soluble fraction, referred to as the “35° C. insoluble fraction,” peaks between 80° C. and 105° C. The 35° C. soluble fraction contains the majority of the hexene in the resin (approximately 15% to 35% of the total resin mass) and consists primarily of low-density materials (those with a density below about 0.890). In contrast, the 35° C. insoluble fraction is composed of medium-density materials, which account for about 65% to about 85% of the resin mass. The 35° C. soluble fraction, with its low-density composition, is characterized by a high molecular weight (Mw>about 80,000) and a narrow molecular weight distribution. Notably, the molecular weights of the soluble fractions eluted between 25° C. and 100° C. exhibit consistent characteristics. The GPC-FTIR analysis further reveals that the polymer composition of the invention shows a uniform distribution of short-chain branching across its molecular weight distribution in both the 35° C. soluble and 35° C. insoluble fractions. In both fractions, the comonomers are evenly distributed along the polyethylene chains, with a distinct absence of low molecular weight species. Additionally, ¹³C NMR analysis indicates that the sequence distribution of the polymers in both the 35° C. soluble and 35° C. insoluble fractions follows Bernoullian statistics, similar to mLLDPE. The film produced from this ethylene-based polymer exhibits exceptional mechanical properties, including a 2% secant modulus greater than about 20,000 psi, dart impact resistance exceeding about 500 g/mil, and machine-direction (MD) tear strength over about 500 g/mil.

The method for producing a film with an enhanced balance of physical and mechanical properties includes reacting ethylene with a comonomer in the presence of a titanium-based prepolymer catalyst at a temperature between 75° C. and 95° C., an ethylene partial pressure of 90 to 120 psia, and a comonomer-to-ethylene ratio of about 0.08 to about 0.15, without additional cocatalysts or antistatic agents during gas-phase polymerization. Titanium-based prepolymer as catalyst system surprisingly broadened the comonomer distribution of inventive polymers, as evidenced by a decrease in the composition distribution breadth index (CDBI) and an increase the solubility distribution breadth index (SDBI). Furthermore, titanium-based prepolymer as catalyst system produced the polymer with narrow molecular weight distribution, as evidenced by a decrease in Mw/Mn. The molecular weight distribution of polymers in the invention was narrower than ZN-LLDPE and super-hexene LLDPE, but wider than mLLDPE. The method further involves extruding the resulting ethylene-based polymer under conditions sufficient to produce a polyethylene film with a 2% secant modulus exceeding about 20,000 psi, a dart impact resistance greater than about 500 g/mil, and an MD tear strength over about 500 g/mil.

The method for producing a film with an optimized balance of physical and mechanical properties comprises reacting ethylene with a comonomer in the presence of a titanium-based prepolymer containing titanium, magnesium, silicon, halogen, nitrogen, and an ethylene homopolymer or copolymer. This prepolymer is prepared by (co)polymerizing ethylene and/or alpha-olefins using a specific Ziegler-Natta catalyst precursor combined with regular alkylaluminum compounds (e.g., n-hexyl aluminum and/or n-octyl aluminum). The prepolymer contains between about 20 and about 500 grams of polyethylene per gram of the solid catalyst precursor. The prepolymer has a particle size distribution span ((d₉₀−d₁₀)/d₅₀) of less than about 1.5, preferably around 1.2. The prepolymer also contains small amounts of fine particles (<80 microns), with fine particle content ranging from about 2 to about 10 wt. %, preferably from about 5 to about 8 wt. %. This prepolymer, when used for olefin polymerization, efficiently prevents fouling of polymer particles in the reactor while producing polymers with a high density or low density (down to 0.9100), offering high catalytic activity, improved operability, and enhanced production efficiency compared to the prior arts. The method further comprises extruding the resulting ethylene-based polymer at conditions sufficient to produce a polyethylene film comprising a 2% secant modulus exceeding about 20,000 psi, a dart impact resistance greater than about 500 g/mil, and an MD tear strength over about 500 g/mil.

### BRIEF DESCRIPTION OF THE DRAWINGS

FIG. 1 depicts the profile of Temperature Rising Elution Fractionation (TREF) for Example 1, in accordance with certain teachings of the present invention.

FIG. 2 depicts the profile of Temperature Rising Elution Fractionation (TREF) for Example 2, in accordance with certain teachings of the present invention.

FIG. 3a depicts the GPC with SCBD profile for the 35° C. soluble fraction of the Example 1, eluted at a temperature less than 35° C., in accordance with certain teachings of the present invention.

FIG. 3b depicts the GPC with SCBD profile for the 35° C. insoluble fraction of the Example 1, eluted at a temperature between 35-105° C., in accordance with certain teachings of the present invention.

FIG. 4a depicts the profile of Cross Fractionation Analysis (CFC) for Example 1, in accordance with certain teachings of the present invention.

FIG. 4b depicts the profile of Cross Fractionation Analysis (CFC) for comparative sample ExxonMobil NTX-095.

FIG. 4c depicts the profile of Cross Fractionation Analysis (CFC) for comparative sample ExxonMobil EXCEED® 1018.

FIG. 4d depicts the profile of Cross Fractionation Analysis (CFC) for comparative sample ExxonMobil EXCEED™ XP.

### DETAILED DESCRIPTION OF THE INVENTION

A polyethylene film exhibiting a distinctive balance of enhanced physical and mechanical properties—particularly tear strength, impact resistance, extrudability, melt strength, tensile strength, and barrier properties—has been developed. It has been unexpectedly found that these improvements are the result of a polymer with a broad composition that is chemically blended of two major fractions (35° C. soluble and 35° C. insoluble fractions) at the molecular level, featuring a unique comonomer distribution, and a molecular weight distribution that is broader than that of metallocene LLDPE but narrower than that of Ziegler-Natta (Z-N) LLDPE. Furthermore, it has been discovered that the comonomer and molecular weight distributions of the polymer are controlled by adjusting either the reactor temperature, ethylene partial pressure, or both, in the presence of a titanium-based prepolymer (namely, “prepolymerized catalyst”) with specific molecular weight and particle size morphology or particle size distribution.

As used herein, the term “prepolymer” or “titanium-based prepolymer” refers to a composition that may include one or more Ziegler-Natta titanium-based components, activators, supports, carriers, polyolefins, or any combination thereof. The terms “prepolymer” and “prepolymerized catalyst” are used interchangeably throughout the present disclosure.

The term “prepolymerization” as used herein means the polymerization of a small amount of olefin on a supported catalyst component prepared for olefin polymerization, thereby forming an olefin polymer on the catalyst component. The term “prepolymerized catalyst” as used herein means a catalyst by prepolymerization of an olefin on a supported catalyst component for olefin polymerization, and referred to simply as a “prepolymer” in this invention. The term “supported” as used herein refers to one or more compounds that are deposited on, contacted with, vaporized with, bonded to, or incorporated within, adsorbed or absorbed in, or on, a support or carrier. The terms “support” or “carrier” for purposes of this specification are used interchangeably and are any support material, preferably a porous support material, including inorganic support materials (e.g. inorganic oxides and inorganic chlorides such as silica, clays, zeolites, talc, aluminum oxide, magnesium compounds) and organic support materials (e.g. polyolefins, polystyrene, or polymeric compounds).

### Prepolymer or Titanium-Based Prepolymer

The prepolymer or titanium-based prepolymer for olefin polymerization, as used in the present invention, is obtained by polymerizing (or prepolymerizing) a specified amount of olefin using a supported titanium-based catalyst precursor (A), along with cocatalysts and an electron-donating compound.

The process for preparing said prepolymer comprises:
i) a supported Ziegler-Natta catalyst precursor (component A) comprising a halide of a transition metal and a nitrogen-based electron donor;
ii) an activator or cocatalyst comprising alkylaluminum
iii) olefin;
iv) optionally one or more alpha-olefins and external donors; and
v) hydrogen

The cocatalysts used in the present invention are alkylaluminum compounds including, but not limited to, triethylaluminum (TEAL), trimethylaluminum (TMA), tri(n-propyl)aluminum, tri(isopropyl)aluminum, tri(n-butyl)aluminum, tri(isobutyl)aluminum, tri(t-butyl)aluminum, trihexylaluminum (THAL), tri(n-octyl)aluminum (TnOA), dimethylaluminum chloride (DMAC), diethylaluminum chloride (DEAC), diisobutylaluminum chloride, ethylaluminum dichloride (EADC), ethylaluminum sesquichloride (EASC), methylaluminum dichloride, and mixtures thereof, or an organohalogenated aluminum compound formed in situ by reacting alkylaluminum with halogenated alkylaluminum compounds.

The supported Ziegler-Natta catalyst precursor (A) is activated using an activator or cocatalyst. The molar ratio of aluminum from the activator to titanium in the catalyst precursor ranges from 0.05 to 500, preferably from 0.5 to 50, and more preferably from 1.0 to 10.0.

The activator may be added prior to introducing the supported catalyst precursor into the prepolymerization medium. The catalyst precursor can also be activated in situ by adding the activator and catalyst precursor separately into the polymerization medium. Alternatively, the catalyst precursor and activator may be combined before being introduced into the polymerization medium, for example, for up to 2 hours at a temperature between 10° C. and 85° C., preferably from 35° C. to 65° C.

The olefins used in prepolymerization include ethylene, propylene, 1-butene, 1-pentene, 1-hexene, 1-octene, 4-methyl-1-pentene, cyclopentene, cyclohexene, and similar compounds. These olefins can be used individually or in combinations of two or more. Preferably, ethylene is used alone, or ethylene is combined with an alpha-olefin comonomer. More specifically, ethylene is most preferably used alone or in combination with at least one alpha-olefin comonomer selected from 1-butene, 1-hexene, and 1-octene.

The method for prepolymerizing a catalyst component for olefin polymerization can be conducted either continuously or batch-wise. Examples include batch-wise slurry polymerization, continuous slurry polymerization, and continuous gas-phase polymerization.

For introducing the catalyst component into the polymerization reactor during prepolymerization, common methods include:
Charging under an anhydrous environment using inert gases such as nitrogen or argon, as well as hydrogen, ethylene, and similar gases; or
Dissolving or diluting the catalyst components in a solvent and charging them into the reactor in the form of a solution or slurry.

When conducting prepolymerization using the slurry polymerization method, saturated aliphatic hydrocarbon compounds are typically used as solvents. Examples include propane, n-butane, isobutane, n-pentane, isopentane, n-hexane, cyclohexane, and heptane. These solvents can be used individually or in combinations of two or more.

Preferred saturated aliphatic hydrocarbons are those with a boiling point of 100° C. or lower at normal pressure, with those having a boiling point of 90° C. or lower being even more preferable. Among these, propane, n-butane, isobutane, n-pentane, isopentane, n-hexane, and cyclohexane are particularly preferred.

When conducting prepolymerization using the slurry polymerization method, the slurry concentration is typically between 0.1 and 600 g of polyethylene per liter of solvent, preferably between 1.0 and 500 g/L.

The prepolymerization temperature generally ranges from 0° C. to 100° C., with a preferred range of 0° C. to 80° C., and more preferably 40° C. to 70° C. The polymerization temperature can be adjusted as needed during the process. The partial pressure of olefins in the gas phase during prepolymerization usually falls between about 0.1 and about 20 bar, preferably between about 1.0 and about 10 bar.

Hydrogen plays a crucial role in influencing the properties of the prepolymer or prepolymerized catalyst system, such as bulk density, powder flowability, and catalytic activity.

The ratio of hydrogen to ethylene is typically between about 0.01 and about 10.0, with a preferred range of about 0.05 to about 1.0. Hydrogen can be introduced either only at the start of the reaction or continuously throughout the reaction.

The prepolymerization time generally ranges from 10 minutes to 15 hours. After prepolymerization, drying of the catalyst particles can be performed using conventional drying equipment, which typically includes a hot nitrogen flush and a solvent condensation system.

Catalyst components for olefin polymerization are classified prior to prepolymerization using an elutriation method. This process separates particles based on size, shape, and density by utilizing a stream of liquid, typically flowing counter to the direction of sedimentation. As a result, the prepolymer for olefin polymerization exhibits improved morphology.

While it is not essential to completely remove fine particles from the prepolymer, reducing their content is crucial. The content of fine particles in the prepolymer should be regulated to 10% by weight or less to achieve the desired properties in the inventive prepolymer.

In this context, “fine particles” refer to particles with a size not exceeding D¹, as defined below, that are present in the prepolymer for olefin polymerization. This regulation ensures the production of a high-quality prepolymer according to the present invention.

The particle size of the fine particles must not exceed D1, as defined by the following formula:

D¹=(average particle size of prepolymer particles)×0.35

In the prepolymer for olefin polymerization according to the present invention, the content of particles with a size no larger than D1 is preferably limited to about 10% by weight or less. A higher content of such fine particles in the prepolymer tends to cause issues such as prepolymer agglomeration, cyclone blockages, and similar complications during olefin polymerization. By maintaining the content of fine particles at about 10% by weight or less, the prepolymer of the present invention effectively prevents these problems.

The average particle size of the prepolymer is influenced by the size of the supported catalyst component and the amount of olefin prepolymerization. Preferably, the average particle size ranges from about 180 μm to about 350 μm. The average particle size of a prepolymer can be determined using established particle size distribution measurement techniques, such as the Malvern Laser Diffraction Analyzer.

The particle size and particle size distribution are measures of the size of particles within a sample. The D-values (D₁₀, D₅₀, and D₉₀) represent the intercepts for 10%, 50% and 90% of the cumulative mass of sample. These D-values can be understood as the diameters of spheres that divide the sample's mass into specified percentages when the particles are arranged in ascending order by mass. For instance, the D₁₀ is the diameter at which 10% of the sample's mass consists of particles smaller than this size. The D₅₀ is the median particle size, where 50% of the sample's mass consists of particles smaller than and 50% consists of particles larger than this value. The D₅₀ value is also called median particle size. The D₉₀ is the diameter at which 90% of the sample's mass is made up of particles smaller than this size. When laser diffraction measurements are performed according to ISO 13320-1 (or ASTM E3340-22), the volumetric D-values are derived, based on the volume distribution of the particles.

The distribution width or span of the particle size distribution is calculated from the D-values D₁₀, D₅₀, and D₉₀ according to the formula:

$$Span = \frac{D 90 - D 10}{D 50}$$

The prepolymer has a particle size distribution span ((D₉₀−D₁₀)/D₅₀) of below about 2.0, and preferably below about 1.5. In one embodiment of the present invention, the prepolymer has a particle size distribution span ((D₉₀−D₁₀)/d₅₀) in the range between about 1.0 and about 2.0, preferably between about 1.0 and about 1.5, more preferably between about 1.0 and about 1.2.

The mean particle size corresponds to the average particle size (APS). From laser diffraction measurements according to ISO 13320-1 (or ASTM E3340-22) the volume based mean particle size is obtained and calculated as follows:

$${\overline{D}}_{pq}^{( p - q )} = \frac{\sum {D}_{i}^{p}}{\sum {D}_{i}^{q}}$$

Wherein D̅=the average or mean particle size
(p−q)=the algebraic power of D_{pq}, whereby p>q
Dᵢ=the diameter of the i^{th} particle
Σ=the summation of Dᵢₚ or D_{iq} representing all particles in the sample

Only in symmetric particle size distributions the mean particle size (corresponding average particle size, APS) and the median particle size D₅₀ have the same value.

In the present invention, the polyolefin polymer content in the prepolymer for olefin polymerization is preferably between about 20 and about 500 g, more preferably between about 25 and about 150 g, and even more preferably between about 40 g and about 100 g, typically per gram of catalyst precursor.

When prepolymer is used for gas-phase polymerization to produce polyethylene for film production, it may be combined with inert diluents to form a slurry, or dried to obtain a free-flowing powder. The drying temperature typically ranges from about 30° C. to 80° C., with a preferred range of about 40° C. to 60° C. The average particle size of the prepolymer is typically between about 180 and about 350 microns, more preferably between about 200 and about 300 microns. Additionally, small amounts of fine particles (<80 microns) may be produced, with the fine particle content typically ranging from about 2% to about 12%, and preferably from about 5% to about 10%. High fine particle content in the prepolymer can lead to issues such as high static and hot spots, which should be avoided in gas-phase polymerization. The melt index (MI) or 12 of the ethylene prepolymer is typically from about 0.01 to about 10 g/10 min, and preferably from about 0.5 to about 2 g/10 min. The solid powder of the prepolymer can be stored under nitrogen for extended periods, typically from about two weeks to a month, while maintaining good activity for subsequent slurry or gas-phase polymerization.

The present invention offers several advantages when using the inventive prepolymer containing a specific amount of polyolefin and catalyst precursor for gas-phase polymerization: a) improved catalyst morphology with reduced fine particle content, which enhances particle flowability, reduces the risk of excessive initial activity, and facilitates the use of the catalyst in gas-phase polymerization within fluidized bed reactors or stirred bed reactors, leading to better operability and increased production efficiency; b) the ability to control the microstructure and chemical composition of the polymer or copolymer produced, such as comonomer composition distribution and molecular weight distribution, enabling the tailoring of polymer properties and the characteristics of films made from the polymer.

This prepolymer for olefin polymerization effectively prevents fouling of polymer particles in the polymerization reactor, even when producing polymers with high or low density (down to about 0.9100 g/cm³). The prepolymer also ensures high catalytic activity, improved operability, and enhanced production efficiency compared to prior art methods.

The supported Ziegler-Natta catalyst precursor (A) for olefin prepolymerization, used to prepare the prepolymer, is a supported titanium-based catalyst component (hereinafter referred to as “component (A)” in some cases). Examples of the Ziegler-Natta catalyst component or titanium-based precursor (component A) used in the present invention include a solid catalyst component formed by contacting the solid magnesium powder, the following component formed by contacting halogen-substituted silane represented by R¹ₓSiX_{y} with alkoxysilane ester represented by R²ₘSi(OR³)ₙ, the following component represented by Ti(OR⁴)₄X₄₋ₐ, the following component containing aromatic nitrogen compound, and the following component represented by RX in the presence of hydrocarbon solvent.

In accordance with one embodiment, a supported Ziegler-Natta catalyst precursor (component A) is prepared by:
(i) contacting spherical magnesium particles with iodine-containing hexane solution in the presence of small quantity of RX and alcohol having the formula ROH, wherein R is C₁-C₂₀ hydrocarbyl or aryl, and X is halogen;
(ii) contacting small quantity of titanium alkyloxide compound having the formula Ti(OR)₄, wherein R is C₁-C₂₀ hydrocarbyl, and wherein each R may be the same or different;
(iii) contacting component (b1) having the formula R¹ₓSiX_{y}, wherein R¹ is C₁-C₂₀ hydrocarbyl, X is halogen, x is an integer between 0 and 3, y is an integer between land 4, and x+y=4, and wherein each X and each R¹ may be the same or different;
(iv) contacting compound (b2) having the formula R²ₘSi(OR³)ₙ, wherein R² and R³ are independently C₁-C₂₀ hydrocarbyl, m is an integer between 0 and 3, n is an integer between 1 and 4, and m+n=4, and wherein each R² may be the same or different and each R³ may be the same or different;
(v) contacting component (b3) of an early transition metal compound having the formula MX₄, wherein X is halogen, M is Ti, Zr, Hf, and V element;
(vi) contacting component (b4) having the formula M(OR⁴)₄, wherein R⁴ is C₁-C₂₀ hydrocarbyl, and wherein each R⁴ may be the same or different, M is Ti, Zr, Hf, and V element;
(vii) contacting component (b5) containing aromatic nitrogen compounds;
(viii) contacting component (b6) having the formula R⁵X, wherein R⁵ is C₁-C₂₀ hydrocarbyl or aryl, and X is halogen

The solid magnesium powder used in the invention has a spherical morphology with a particle size ranging from about 50 to about 60 microns. Typically, the magnesium powder used in catalyst preparation is received in a slightly oxidized form, with an estimated 1-3% MgO layer on its surface. This MgO on the surface inhibits the Grignard reactions with R⁵X to efficiently form MgX₂ support/activator for the supported Ziegler-Natta catalyst precursor (A). A small quantity of iodine is introduced, as iodine is a classic initiator for Grignard reactions, likely leading to the formation of MgI. It is preferable to maintain the solvent at ambient temperature before and after introducing iodine. Small quantities of alcohol (ROH) and titanium alkoxide, along with its equivalent molar ratio of RX, are introduced to remove the MgO layer from the surface of the solid magnesium powder. This process occurs at temperatures ranging from 25 to 100° C., with the mixture being heated for 30 to 60 minutes, preferably 45 to 60 minutes, in a non-polar solvent at temperatures between 50 to 100° C., and ideally between 75 to 85° C.

The component (b1) used in the present invention is a halogen-substituted silane, which has the formula R¹ₓSiX_{y}. In this formula, R¹ is a C₁-C₂₀ hydrocarbyl group, which includes both unsubstituted and substituted species, including halogen-substituted species. X represents a halogen, x is an integer between 0 and 3, y is an integer between 1 and 4, and x+y=4. More than one halogen (X) may be employed in the halogen-substituted silane. Suitable halogen-substituted silane compounds include silicon tetrachloride, tetrabromosilane, tetrafluorosilane, benzyltrichlorosilane, bis(dichlorosilyl)methane, 2-bromoethyltrichlorosilane, t-butyldichlorosilane, t-butyltrichlorosilane, 2-(carbomethoxy)ethyltrichlorosilane, 2-chloroethylmethyl dichlorosilane, 2-chloroethyltrichlorosilane, 1-chloroethyltrichlorosilane, chloromethylmethyldichlorosilane, ((Chloromethyl)phenylethyl)trichlorosilane, chloromethyltrichlorosilane, 2-cyanoethylmethyldichlorosilane, cyclohexyltrichlorosilane, cyclopentyltrichlorosilane, cyclotetraemethylenedichlorosilane, cyclotrimethylenedichlorosilane, 1,5-dichlorohexamethyltrisiloxane, (dichloromethyl)trichlorosilane, dichlorosilane, 1,3-dichlorotetramethyldisiloxane, diethyoxydichlorosilane, ethylmethyldichlorosilane, ethyltrichlorosilane, heptyltrichlorosilane, hexachlorodisilane, hexachlorodisiloxane, isobutyltrichlorosilane, methyltrichlorosilane, octyltrichlorosilane, pentyltrichlorosilane, propyltrichlorosilane, and trichloromethyltrichlorosilane. It is preferred to employ tetrachlorosilane or silicon tetrachloride, allyltrichlorosilane, ethyltrichlorosilane, methyltrichlorosilane, and dichlorodiphenylsilane.

The component (b2) used in the present invention is an alkoxysilane ester compound. Suitable alkoxysilane ester compounds have the formula R²ₘSi(OR³)ₙ, where R² and R³ are independently any C₁-C₂₀ hydrocarbyl group, which includes both unsubstituted and substituted species, including halogen-substituted species. In this formula R²ₘSi(OR³)ₙ, m is an integer between 0 and 3, n is an integer between 1 and 4, and m+n=4. Multiple hydrocarbyl or substituted hydrocarbyl groups can be employed for both the R² and R³ components. Specific alkoxysilane ester compounds include tetramethoxysilane, tetraethoxysilane, tetraisopropoxysilane, tetrapropoxysilane, tetraethoxysilane, tetraisobutoxysilane, tetraphenoxysilane, tetra(p-methylphenoxy)silane, tetrbenzyloxysilane, tetrakis(2-methoxyethoxy)silane, tetrakis(2-ethylhexoxy)silane, tetraallyloxysilane, methyltrimethoxysilane, methyltriethoxysilane, mehtyltributoxysilane, methyltriphenoxysilane, ethyltriethoxysilane, ethyltriisobutoxysilane, ethyltriphenoxysilane, allyltrimethoxysilane, octadecyltrimethoxysilane, octadecyltriethoxysilane, octyltriethoxysilane, phenyltrimethoxysilane, phenyltriethoxysilane, benzyltriphenoxysilane, methyltrialllyloxysilane, dimethyldimethoxysilane, dimethyldiethoxysilane, dimethyldiisopropyloxysilane, dimethyldibutoxysilane, dimethyldihexyloxysilane, dimethyldiphenoxysilane, diethyldiethoxysilane, diethyldiisobutoxysilane, diethyldiphenoxysilane, dibutyldiisopropyloxysilane, dibutyldibutoxysilane, dibutyldiphenoxysilane, diisobutyldiethoxysilane, diisobutyldiisobutoxysilane, diphenyldimethoxysilane, diphenyldiethoxysilane, diphenyldibutoxysilane, dibenzyldiethoxysilane, divinyldiphenoxysilane, diallyldipropoxysilane, diphenyldiallyoxysilane, 1,1,1,3,3-pentamethyl-3-acetoxydisiloxane, triethoxysilane, trimethoxysilane, triethoxychlorosilane, and trimethoxychlorosilane. Particularly preferable compounds are tetramethoxysilane, tetraethoxysilane, tetraisopropoxysilane, tetrapropoxysilane, tetrabutoxysilane, tetraisobutoxysilane, and combination thereof.

Component (b1) can react with component (b2) to form an organic silicon complex, which is prepared in situ by reacting an alkoxysilane ester, R²ₘSi(OR³)ₙ, with a halogen-substituted silane, Ri_{X}SiX_{y}. This reaction is preferably conducted in the presence of magnesium and a halogenated alkyl group, such as an alkyl chloride, which is believed to form an alkyl magnesium halide, although this is not intended to limit the process. The mixture is heated for 30 to 60 minutes, preferably 45 to 60 minutes, in a non-polar solvent at temperatures ranging from 50 to 100° C., with a more preferred range of 65 to 85° C.

The reactions between alkoxysilane esters and halogen-substituted silanes, such as silicon tetrachloride (SiCl₄), are described by M. G. Voronkov, V. P. Mileshevich, and A. Yu in the book The Siloxane Bond, Plenum Publishing Corp., New York, 1978. The reaction is typically carried out in a non-polar solvent by heating the mixture to temperatures ranging from 50° C. to 100° C., with a preferred range of 65° C. to 85° C. The duration of heating is not usually critical, but an acceptable procedure involves heating for 30 to 60 minutes once the desired temperature is reached. The molar ratio of alkoxysilane ester to halogen-substituted silane is typically between 0.5 and 3.0, with a more preferred range of 0.8 to 1.5. Some excess alkoxysilane ester may remain unreacted in the final organic silicon product. This organic silicon product is often used in the subsequent steps in situ, without further separation or characterization.

The component (b3) used in the present invention is an early transition metal compound with the formula MX₄, where X is a halogen and M is an element selected from Ti, Zr, Hf, and V, with titanium halide compounds being preferred. The component (b4) is also an early transition metal compound with the formula M(OR⁴)₄ and/or Ti(OR⁴)₃X, where R⁴ is a C₁-C₂₀ hydrocarbyl group, which may be the same or different for each R⁴, X is a halogen, and M is Ti, Zr, Hf, or V. Titanium alkoxides, such as Ti(OR⁴)₄, are particularly preferable.

Examples of the titanium halide compound include TiCl₄, TiBr₄, TiI₄, TiCl₃·nTIF and 3TiCl₃·AlCl₃. Among these titanium halides, TiCl₄ and 3TiCl₃·AlCl₃ are more preferable.

Titanium compounds with the structural formula Ti(OR⁴)₄ or Ti(OR⁴)₃X include trimethoxymonochlorotitanium, triethoxyfluorotitanium, triethoxychlorotitanium, tetraethoxytitanium, tripropoxyfluorotitanium, tripropoxychlorotitanium, tetra-n-propoxytitanium, tetraisopropoxytitanium, tributoxyfluorotitanium, tributoxychlorotitanium, triisobutoxychlorotitanium, tetra-n-butoxytitanium, tetra-isobutoxytitanium, dipentoxydichlorotitanium, tripentoxymonochlorotitanium, tetra-n-pentyloxytitanium, tetracyclopentyloxytitanium, trioctyloxymonochlorotitanium, 2-ethylhexoxytitanium trichloride, butoxytitanium trichloride, tetra-n-hexyloxytitanium, tetracyclohexyloxytitanium, tetra-n-heptyloxytitanium, tetra-n-octyloxytitanium, tetra-2-ethylhexyloxytitanium, tri-2-ethylhexyloxymonochlorotitanium, tetranonyloxytitanium, tetradecyloxytitanium, tetraisobornyloxytitanium, tetraoleyloxytitanium, tetraallyloxytitanium, tetrabenzyloxytitanium, tetrabenzohydryloxytitanium, triphenoxytitanium, tetr-o-methylphenoxytitanium, tetraphenoxytitanium, tetra-o-methylpheoxytitanium, tetra-m-mehtylpheoxytitanium, tetra-o-methylphenoxytitanium, tetra-m-methylphenoxytitanium, tetra-1-naphthyloxytitanium, tetra-2-napthyloxytitanium and mixtures thereof. The preferred Ti(OR⁴)₄ or Ti(OR⁴)₃X compounds are 2-ethylhexoxytitanium trichloride, butoxytitanium trichloride, tetra-n-propoxytitanium, tetraisopropoxytitanium, tetra-n-butoxytitanium, tetraisobutoxytitanium, dibutoxydichlorotitanium, isobutoxytrichlorotitanium and propoxytrichlorotitanium.

The component (b5) used in the present invention is pyridine and/or the substituted pyridine. Representative examples of the compounds include pyridine, 2-methylpyridine, 4-methylpyridine, 2-ethylpyridine, 4-ethylpyridine, 4-tert-butylpyridine, 2-[methylamino]methyl]pyridine, 2,6-dimethylpyridine, 2,6-diisopropylpyridine, 2,6-di-tert-butylpyridine, 2-phenyl-6-propyl-pyridine, 2-methyl-6-phenyl-pyridine, 2, 6-trimethylsilyl-pyridine, 2,6-dimethoxypyridine, 2,6-bis(chloromethyl)-pyridine, 2,2′:6′,2′-terpyridine, 4′-(4-methylphenyl)-2,2′:6′,2″-terpyridine, 6,6′-dimethyl-2,2′-dipyridyl.

The component (b5) used in the present invention is preferably employed in amounts sufficient to achieve a molar ratio of component (b5) to the transition metal compound added in the previous step, typically ranging from 0.01:1 to 50:1, more preferably from 0.02:1 to 10:1, and most preferably from 0.1:1 to 5:1. While the reaction conditions are not generally critical, an acceptable procedure involves heating the mixture at 80° C. for 30 to 100 minutes, preferably for 60 minutes, once the desired temperature is reached. The resulting solution is generally a dark brown color and can be used directly in subsequent steps without further separation or characterization.

The component (b6) used in the present invention is an alkyl or aromatic halide compound. Suitable alkyl or aromatic halides are represented by the formula R⁵X, where R⁵ is either an alkyl group typically containing 3 to 20 carbon atoms or an aromatic group typically containing 6 to 18 carbon atoms, and X is a halogen, typically chlorine or bromine. Examples of such halides include, but are not limited to, butyl chloride and chlorobenzene.

The supported catalyst precursor (A) for olefin polymerization is obtained by reacting magnesium with components (b1-b6) as described above. Specifically, the magnesium halide composite support is prepared in situ by reacting metallic magnesium with an alkyl or aromatic halide (b6) in the presence of components (b1-b5) at a temperature of 75° C. to 90° C., preferably 75° C. to 80° C., for 3 to 8 hours.

The molar ratio of alkyl or aromatic halide (b6) to metallic magnesium is typically from about 1.0 to about 4.0, with a preferred range of about 2.0 to about 2.5. The ratio of component (b5) to metallic magnesium ranges from about 0.01 to about 1.0, preferably from about 0.05 to about 0.5. For component (b3), the ratio to metallic magnesium is from about 0.15 to about 1.0, preferably from about 0.25 to about 0.50. Lastly, the ratio of component (b1) to metallic magnesium is from about 0.25 to about 2.0, with a preferred range of about 0.5 to about 1.5.

The supported catalyst precursor (A) for olefin polymerization is prepared in a non-polar solvent. Suitable non-polar solvents are those in which the reactants, such as the silicon compound, transition metal compound, and electron donors, are at least partially soluble and remain liquid at the reaction temperatures. Preferred non-polar solvents include saturated hydrocarbons, such as alkanes (e.g., isopentane, hexane, heptane, octane, nonane, and decane). To prevent exposure to air, the reaction can be carried out under a nitrogen atmosphere.

The supported catalyst precursor (A) can be stored in a slurry state under nitrogen for subsequent pre-polymerization or dried into a powder form for use in preparing prepolymer for olefin polymerization.

### Polymerization Process

The prepolymer described above is suitable for use in various olefin polymerization processes, including solution, gas phase, slurry phase, high-pressure processes, or combinations thereof. In the present invention, gas phase polymerization is preferred, with a continuous gas phase polymerization process being especially preferred.

A preferred method for producing linear low-density polyethylene (LLDPE) resins involves a gas phase process, which may utilize stirred bed reactors or fluidized bed reactors.

Notably, no additional cocatalyst is required in the polymerization of alpha-olefins to produce olefin polymers when using the inventive prepolymer prepared by the described production method.

The method for producing an olefin polymer according to the present invention involves polymerizing an olefin using the prepolymer described above. This polymerization process encompasses both homopolymerization and copolymerization, resulting in polymers that may be either homopolymers or copolymers.

The olefin used in the polymerization process may be the same as or different from the olefin employed in the prepolymerization step. Additionally, a combination of multiple olefins can be used in the polymerization process.

The process to produce said olefin polymer comprises reacting at least the following components with each other:
i) said prepolymer as described above, without adding additional cocatalyst
ii) ethylene;
iii) optionally one or more alpha-olefins;
iv) optionally external donor or modifier
v) hydrogen

The olefins used for polymerization include those with 2 to 30 carbon atoms, or 2 to 12 carbon atoms in another embodiment. Suitable olefins include ethylene, propylene, 1-butene, 1-pentene, 1-hexene, 1-octene, 1-nonene, 1-decene, 1-dodecene, 4-methyl-1-pentene, 4-methyl-1-hexene, and similar compounds. These olefins may be used individually or in combinations of two or more. Preferred olefins include ethylene, 1-butene, 1-hexene, 4-methyl-1-pentene, and 1-octene.

The method for producing an olefin polymer according to the present invention is particularly suitable for the copolymerization of ethylene with an alpha-olefin having 3 to 20 carbon atoms. Examples of ethylene and alpha-olefin combinations include ethylene/1-butene, ethylene/1-hexene, ethylene/4-methyl-1-pentene, ethylene/1-octene, ethylene/1-butene/1-hexene, ethylene/1-butene/4-methyl-1-pentene, ethylene/1-butene/1-octene, ethylene/1-hexene/1-octene, and similar combinations. Preferred combinations are ethylene/1-hexene, ethylene/4-methyl-1-pentene, ethylene/1-butene/1-hexene, ethylene/1-butene/1-octene, and ethylene/1-hexene/1-octene.

In a preferred embodiment, a copolymer comprising ethylene-derived units and one or more comonomers is produced. The comonomers are preferably alpha-olefins having 4 to 15 carbon atoms in one embodiment, 4 to 12 carbon atoms in another embodiment, and 4 to 8 carbon atoms in yet another embodiment.

The standard polymerization conditions for producing polyolefin polymers using the method of the present invention should be carefully selected, including factors such as polymerization temperature, time, pressure, monomer concentration, and hydrogen concentration.

In general, the polymerization temperature should be below the sintering temperature of the polymer particles for gas-phase polymerization. For ethylene copolymer production, temperatures in the range of 30° C. to 120° C. are acceptable, with a preferred range of 50° C. to 110° C., and an even more preferred range of 70° C. to 100° C. Specifically:
To produce LLDPE products with a density of 0.90 to 0.92 g/mL, a temperature range of about 70° C. to about 100° C. is recommended.
For LLDPE products with a density of 0.92 to 0.94 g/mL, temperatures between about 80° C. and about 105° C. are preferred.
To prepare LLDPE products with a density of 0.94 to 0.96 g/mL, temperatures between about 90° C. and about 120° C. are used.

The molecular weight of the resulting polymers can be adjusted through the use of hydrogen during polymerization. This control is reflected in changes to the polymer's melt indices (I₂ and I₂₁). The catalyst system described in the present invention allows for effective regulation of the molecular weight within these conditions.

Copolymerizing alpha-olefin comonomers with ethylene to achieve a comonomer content of about 1 to 5 mol percent results in the desired density ranges for the copolymer. The specific amount of comonomer required to achieve these results will depend on the particular comonomer(s) used. It has been observed that in a gas-phase catalytic polymerization reaction, comonomers such as 1-butene, 1-hexene, and 4-methyl-1-pentene can be incorporated into ethylene-based copolymer chains with high efficiency. Even relatively low concentrations of these comonomers in the gas-phase reactor can lead to substantial incorporation into the resulting copolymer. For example, 1-butene, 1-hexene, or 4-methyl-1-pentene present in amounts up to about 18 percent by weight preferably in the range of about 2 to about 12 percent by weight can produce LLDPE resins with a density of less than about 0.940 g/mL.

LLDPE resins may be copolymers of ethylene with one or more C₃-C₁₀ alpha-olefins, resulting in copolymers containing two types of monomer units, or terpolymers containing three types of monomer units. Examples of such polymers include, but are not limited to, ethylene/1-butene copolymers, ethylene/1-hexene copolymers, ethylene/4-methyl-1-pentene copolymers, as well as ethylene/propylene/1-butene terpolymers, ethylene/propylene/1-hexene terpolymers, and ethylene/1-butene/1-hexene terpolymers. Preferred comonomers include 1-hexene, 4-methyl-1-pentene, propylene, 1-butene, and mixtures thereof, with 1-hexene being especially preferred.

The method of producing olefin polymers according to the present invention allows for stable and continuous polymerization of olefins. This is achieved without issues such as agglomeration of the prepolymer, blockage of the cyclone, or other operational problems commonly encountered in polymerization reactors. The use of a prepolymer for olefin polymerization, as described in the present invention, ensures smooth, trouble-free processing during the polymerization process.

The copolymer produced in accordance with the present invention typically has a density of about 0.960 g/mL or less, preferably about 0.952 g/mL or less, and more preferably about 0.940 g/mL or less. Density is measured according to ASTM D1505-98. In certain embodiments of the invention, densities as low as about 0.910 g/mL or even as low as about 0.870 g/mL can be achieved.

Copolymer resins produced in accordance with the present invention preferably contain at least about 75 weight percent ethylene units. Additionally, the copolymer resins may include from about 0.5 to 25 weight percent of an alpha-olefin, with more than about 0.5 weight percent of the alpha-olefin being preferred.

The molecular weight of the copolymers can be controlled in a known manner, preferably through the use of hydrogen. With the catalysts produced according to the present invention, molecular weight can be effectively regulated by introducing hydrogen during polymerization, which is carried out at temperatures ranging from about 20° C. to 300° C. This control over molecular weight is typically reflected in a measurable positive change in the melt index (2).

The melt flow index (MFI) of the polymer is measured at 190° C., according to ASTM D1238. The melt flow ratio (MFR), defined as the ratio of the high melt flow index (HLMI or I₂₁) to the melt index (MI or 12), is used as an indicator of melt fluidity and to assess the molecular weight distribution of the polymer.

In a typical gas phase polymerization process a continuous cycle is employed wherein on part of the cycle of a reactor system, a cycling gas stream, otherwise known as a recycle stream or fluidizing medium, is heated in the reactor by the heat of polymerization. This heat is removed from the cycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer.

It has been surprisingly found that films exhibiting a unique balance of dart impact and machine direction (MD) tear can be produced by controlling the reactor temperature, ethylene partial pressure, or both, in the presence of the inventive prepolymerized catalyst (or prepolymer).

Additionally, films with an exceptional balance of machine direction (MD) and transverse direction (TD) tear properties, and/or films in which MD tear increases with MD shrinkage, are produced under similar conditions.

The reactor temperature should be maintained between about 60° C. and about 120° C., preferably between about 70° C. and about 110° C., more preferably between about 75° C. and about 105° C., and most preferably between about 80° C. and about 100° C. The ethylene partial pressure should range from about 80 to about 250 psia, preferably between about 90 and about 220 psia, more preferably between about 100 and about 200 psia, and most preferably between about 100 and about 150 psia. The reactor pressure is typically maintained between about 250 and about 350 psia.

Furthermore, the ratio of comonomer to ethylene in the gas phase should be maintained between about 0.0 and about 0.25, preferably between about 0.05 and about 0.20, more preferably between about 0.08 and about 0.18, and most preferably between about 0.10 and about 0.15.

### Polymer Products

The polymers of the invention have a density in the range of from about 0.85 g/cc to about 0.97, preferably in the range of from about 0.90 g/cc to about 0.95 g/cc, more preferably in the range of from about 0.910 g/cc to about 0.940 g/cc, and most preferably in the range of from about 0.910 g/cc to about 0.930 g/cc. Density is measured in accordance with ASTM-D1238.

The polymers made by the described processes have a melt index (MI) or (I₂) as measured by ASTM-D1238E (190/2.16) in the range from about 0.1 to about 50 dg/min, preferably between about 0.2 and about 10 dg/min, more preferably between about 0.3 and about 5 dg/min, and most preferably between about 0.5 and about 4.0 dg/min.

The polymers produced will have a weight average molecular weight ranging from about 80,000 to about 150,000, with corresponding melt index (I₂, 190° C./2.16 kg) values between about 3 and about 0.5 dg/min. For these polyolefin resins, the melt flow ratio (MFR), defined as the ratio of I₂₁ to I₂, is typically between >about 20 and <about 30, and more preferably between >about 24 and <about 28.

In one embodiment, the polymers have a melt index ratio (I₂₁/I₂) (I₂₁ is measured by ASTM-D1238F) (190/21.6) of from about 20 to less than about 50. The polymers have a melt index ratio (I₂₁/I₂) of between about 20 and about 30, more preferably between about 23 and about 28, most preferably between about 24 and about 26.

Molecular weight measurements were carried out using a high temperature size exclusion chromatograph (SEC) (Polymer Char) equipped with a differential refractive index (DRI) and infrared (IR) (PolyChar, IR4) detectors, a Viscotek model 210R viscometer, and a multi-angle laser light scattering (MALLS) apparatus (Wyatt, DAWN EOS). All measurements were taken at 145° C. using 1,2,4-trichlorobenzene (TCB) as the solvent. The system was calibrated with a standard material (NBS 1475) with a weight-average molecular weight of 52000 g/mol and an intrinsic viscosity of 1.01 dL/g. The refractive index increment, dn/dc, was calculated from the calibrated DRI detector as 0.11 mL/g. Molecular weights for the polyethylene polymers of the present invention were calculated from the intrinsic viscosity detector using the following Mark-Houwink parameters; K=4.5×10⁻⁴ dL/g and a=0.735, established for linear polyethylene from a polystyrene calibration.

SEC with the multiple detectors can detect differences between the hydrodynamic volume of linear and branched polymers. Simultaneous measurement of intrinsic viscosity [η], and absolute molecular weight, MLS, for each fraction of polymer separated by the chromatography columns can provide information about the structure of branched polymers. Mark-Houwink plots (log[η] vs log [M_{w}]) for each slice of the SEC elution, can be used to qualitatively observe branching. The linear standard polyethylene polymers behave in a fashion described by the Mark-Houwink relation: [η]=KM^{a}, where K and a can be obtained from the slope and intercept of the Mark-Houwink plot. However, branched polymers begin to deviate from linear behavior at high molecular weights, that is, the slopes of the Mark-Houwink plot for the branched polymer deviate from that of the linear standard. The deviation from linear behavior is subtle at low branch point density but became more apparent as branch point density is increased. In accordance with certain teachings of the present invention, this deviation from linear behavior is observed in the high molecular weight fractions of the inventive samples, that is, the inventive samples have long branched polymer chains. In contrast, the comparative samples conform to the linear relationship of Mark-Houwink plot in all the molecular weight fractions, indicating they do not contain any long chain branching in the polymers. Short chain branching distribution (SCBD) data can be obtained using a SEC-FTIR high temperature heated flow cell (Polymer Laboratories), as described in P. J. DesLauriers, D. C. Rohlfing, and E. T. Hsieh, Quantifying short chain branching microstructures in ethylene 1-olefin copolymers using size exclusion chromatography and Fourier transform infrared spectroscopy (SEC-FTIR), Polymer, 2002, 43, 159, which are incorporated herein by reference.

Unlike conventional Ziegler-Natta polymers, the polymers of the invention maintain a relatively constant melt index ratio (I₂₁/I₂) in the range of about 26 to about 28, across a density range of about 0.910 to about 0.950. In contrast, the melt index ratio (I₂I₂) of conventional Ziegler-Natta polymers increases noticeably as the polymer density decreases. These findings suggest that the polymers of the invention exhibit a consistently narrow molecular weight distribution (MWD) within the density range of 0.910 to 0.950, in contrast to the broader MWD typically seen in traditional Ziegler-Natta polymers.

The polymers of the invention exhibit a narrower molecular weight distribution (MWD) compared to traditional Ziegler-Natta polymers and even Super-Hexene, but a broader MWD when compared to metallocene polymers. The molecular weight distribution, as indicated by the weight average molecular weight to number average molecular weight ratio (polydispersity index, M_{w}/Mₙ), for the polymers of the present invention ranges from about 2.5 to about 5.0, preferably from about 2.5 to about 4.5, more preferably from about 3.0 to about 4.0, and most preferably from about 3.4 to about 3.8.

In contrast, typical metallocene LLDPE polymers have a polydispersity index (M_{w}/Mₙ) in the range of about 2.0 to about 3.0, while conventional Ziegler-Natta LLDPE polymers typically have an M_{w}/Mₙ in the range of about 3.8 to about 4.5. The polymers of the invention also have an M_{z}/M_{w} ratio (z-average molecular weight to weight average molecular weight) greater than about 2.5, which distinguishes them from metallocene LLDPE polymers but aligns them more closely with conventional Ziegler-Natta LLDPE polymers. The M_{z}/M_{w} ratio for typical metallocene LLDPE is generally between about 2.0 and about 2.5, while for conventional Ziegler-Natta polymers, it is typically above about 2.5.

In one embodiment, the M_{z}/M_{w} ratio for the polymers of the invention ranges from about 2.5 to about 3.8, and in another embodiment, it ranges from about 2.5 to about 3.5. The M_{z}/M_{w} ratio is indicative of inter- and/or intra-macromolecular entanglement, which contributes to unique polymer rheological behavior, enhancing the tensile strength and strain modulus of the resulting films.

The polymers of the invention exhibit a uniform composition distribution, where comonomers are incorporated into the high molecular weight polymer molecules and are evenly distributed across the entire polyethylene chains, with a significant absence of low molecular weight polymer species. Specifically, the polymers of the invention feature a substantially constant or flat short chain branch distribution, or in some cases, a reversed distribution across the molecular weight spectrum or across chains of different molecular weights. This distribution pattern is comparable to metallocene-catalyzed polyethylene (mLLDPE), but differs from conventional Ziegler-Natta (titanium-based) polyethylene (ZN-LLDPE) and Super-hexene ZN-LLDPE.

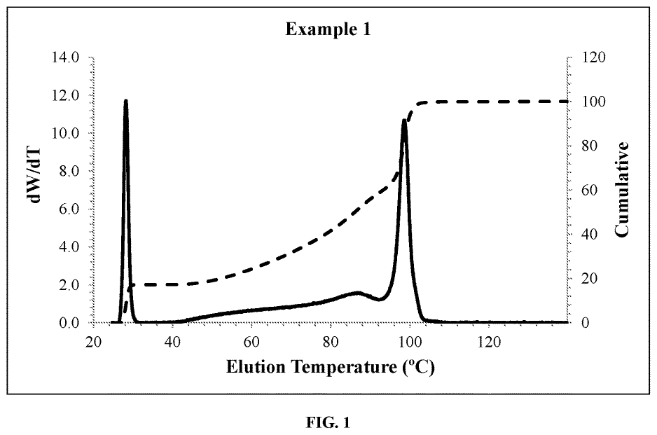

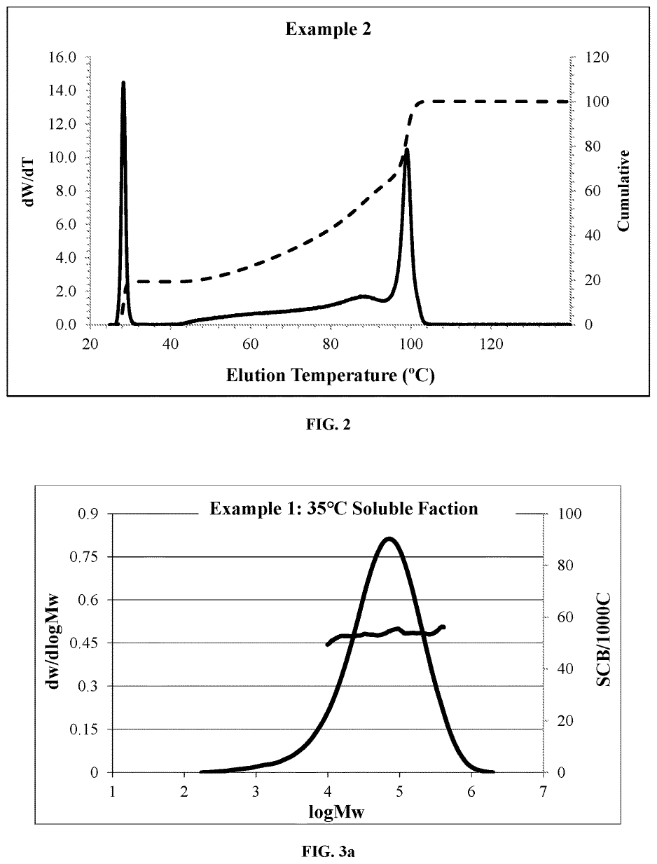

The polymers consist of two distinctive peaks from TREF analysis (see FIG. 1 and FIG. 2). Specifically, the most soluble material exhibits a peak elution temperature between about 25° C. and about 35° C., while another soluble material peaks between about 80° C. and about 105° C.

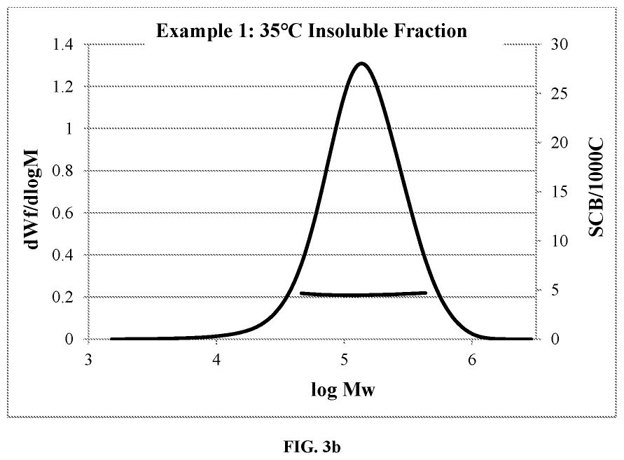

A fraction of the inventive polymer that is soluble at temperatures below 35° C. contains at least 15 wt % of the total polymer, with an average molecular weight (M_{w}) greater than 90,000 g/mol, and a uniform or reversed short chain branch distribution across the molecular weight distribution or across chains of different molecular weights (FIG. 3a). A fraction of the inventive polymer that is soluble at temperatures above 35° C. contains at least 65 wt %, with an average molecular weight (Mw) greater than 90,000 g/mol, and similarly exhibits a uniform or reversed short chain branch distribution across the molecular weight distribution or across chains of different molecular weights (FIG. 3b).

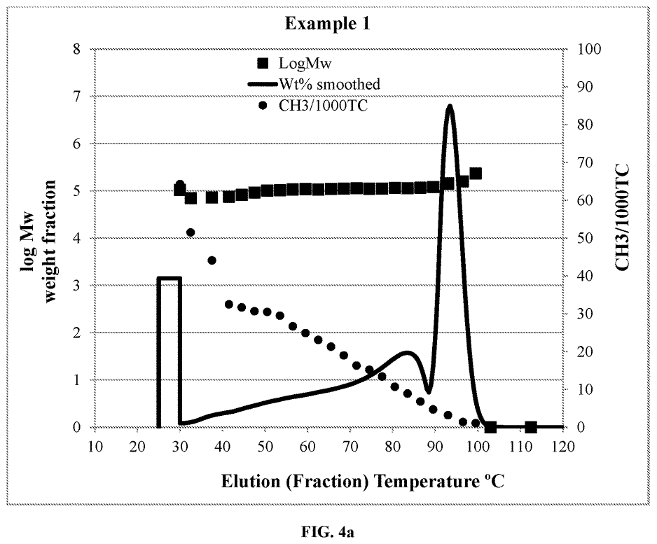

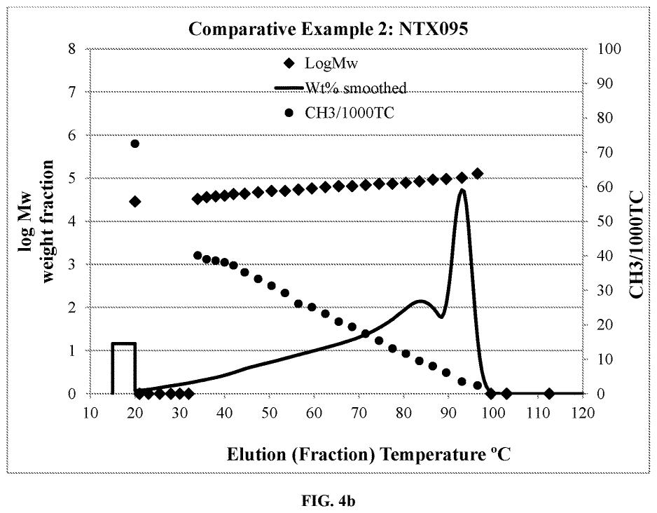

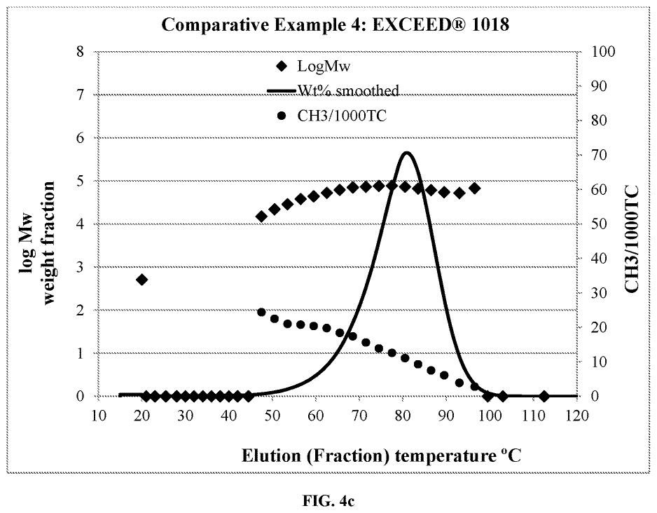

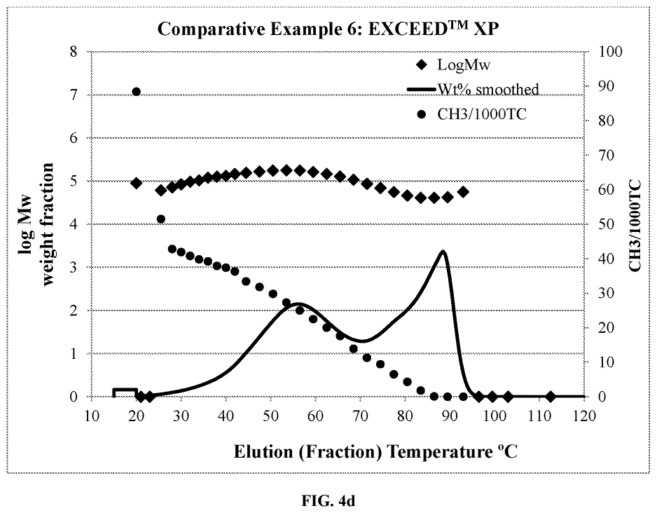

The weight average molecular weight (Mw) of each fraction in the inventive polymer exhibits a substantially constant distribution across the elution temperature range from about 20° C. to 105° C. (FIG. 4), as determined by Cross Fractionation Analysis (CFC). CFC is conducted using Polymer Char's CFC Instrument, which measures the Bivariate Distribution through analytical Temperature Rising Elution Fractionation (TREF) or Thermal Gradient Interaction Chromatography (TGIC) fractionation, followed by online Gel Permeation Chromatography (GPC) analysis of the fractions. This process yields 3D plots and profiles of the recovered TREF/TGIC and GPC data in a single analysis, using an infrared (IR) detector (IR5).

Polymer Char's procedure utilizes a commercial TREF instrument to fractionate the resin into chemical composition fractions, which are then analyzed by GPC methodology. The procedure involves sequential TREF separation, followed by GPC analysis. Approximately 100-150 mg of the sample is dissolved in 20 mL of o-DCB. An aliquot of the solution (0.5 mL) is loaded onto the instrument's column, crystallized, and fractionated by stepwise temperature increases under a fixed pump flow rate. About 0.5 mL portions of the fractions emerging from the TREF fractionation at each temperature step are passed through a GPC column heated to 150° C., with a volumetric flow rate of 1 mL/min, and then through the infrared detector. GPC chromatograms for each fraction obtained from the TREF fractionation at each temperature step are recorded for analysis.

Another important characteristic of the polymer of the invention is its composition distribution (CD). An important characteristic of the polymer described in this invention is its composition distribution (CD). The composition distribution was analyzed using the Analytical Temperature Rising Elution Fractionation (TREF) technique, performed on a PolyChar TREF 200+instrument. For the analysis, 40 mg of the polymer sample was dissolved in 20 mL of 1,2,4-trichlorobenzene within the vessel. An aliquot of the prepared polymer solution was then introduced into the column. The solution was cooled at a rate of 0.5° C./min to a temperature of 35° C. Subsequently, elution was conducted at a flow rate of 0.5 mL/min, with the temperature gradually increased at 1° C./min until reaching 140° C.

The CRYSTAF instrument is a fully automated system designed for rapid measurement of the Chemical Composition Distribution (CCD) in polyolefins. It utilizes the Crystallization Analysis Fractionation technique to separate polymers based on their comonomer content. During the process, the polymer is first dissolved in an appropriate solvent at elevated temperatures. The solution's temperature is then gradually reduced, promoting the slow crystallization of the polymer. This entire process is conducted in a single temperature ramp (crystallization step), with the polymer solution concentration continuously monitored using Polymer Char's IR4 Infrared Detector.

Additionally, the CRYSTAF instrument can be upgraded to a CRYSTAF-TREF combined system, enabling it to perform both Crystallization Analysis Fractionation and Temperature Rising Elution Fractionation (TREF) using the same hardware. These complementary techniques provide detailed insights into the CCD of complex polymer resins. Each technique can provide complementary information on the CCD in some complex resins.

As is well known in the prior art, the composition distribution of a copolymer refers to the uniformity of comonomer incorporation among the copolymer molecules. Metallocene catalysts are recognized for their ability to incorporate comonomer uniformly across the polymer molecules they produce. Consequently, copolymers synthesized using a single metallocene catalyst exhibit a very narrow composition distribution, meaning most polymer molecules have a similar comonomer content, with the comonomer randomly distributed within each molecule. In contrast, conventional Ziegler-Natta catalysts typically produce copolymers with a much broader composition distribution, where comonomer incorporation varies significantly among individual polymer molecules.

The “Composition Distribution Breadth Index” (CDBI) is a metric used to measure the composition distribution of a copolymer. CDBI is defined as the weight percentage of copolymer molecules that have a comonomer content within 50% of the median total molar comonomer content (±25% around the median). This specific definition is often referred to as “CDBI₅₀.”

The CDBI of a copolymer can be determined using established techniques for isolating individual fractions of the copolymer sample. One such method is Temperature Rising Elution Fractionation (TREF), which can be performed in conjunction with Crystallization Analysis Fractionation (CRYSTAF). These techniques are detailed in Wild et al., J. Poly. Sci. Poly. Phys. Ed., vol. 20, p. 441 (1982); U.S. Pat. No. 5,008,204; and Andreas et al., J. Appl. Polym. Sci., vol. 133, p. 43089 (2016), all of which are incorporated herein by reference.

To determine the Composition Distribution Breadth Index (CDBI) or the Solubility Distribution Breadth Index (SDBI), a solubility distribution curve for the copolymer is first generated. This can be achieved using data obtained from the Temperature Rising Elution Fractionation (TREF) technique described earlier. The solubility distribution curve represents the weight fraction of the copolymer that becomes solubilized as a function of temperature. This curve is then transformed into a weight fraction versus composition distribution curve. From this composition distribution curve, the CDBI is calculated by determining the weight percentage of the sample with a comonomer content within ±25% of the median comonomer content. Further details on determining the CDBI or SDBI for a copolymer are well-known to those skilled in the art and can be found in PCT Patent Application WO 93/03093, which is incorporated herein by reference.

The polymers described in this invention typically exhibit a broad composition distribution, as measured by the Composition Distribution Breadth Index (CDBI) or Solubility Distribution Breadth Index (SDBI). Polymers produced using the prepolymer described herein have a CDBI₅₀ of less than about 35%, preferably less than about 30%, and most preferably less than about 28%. In specific embodiments, the polymers have a CDBI₅₀ ranging from about 20% to less than about 30%. In another embodiment, the CDBI₅₀ is from about 20% to about 24%. In yet another embodiment, the CDBI₅₀ is from about 24% to about 28%. Similarly, these polymers have a SDBI of less than about 35° C., preferably less than about 30° C. but greater than about 23° C. In specific embodiments, the polymers have a SDBI ranging from about 23° C. to less than about 28° C. In another embodiment, the SDBI ranges from about 25° C. to about 30° C.

Another important characteristic of the polymers described in this invention is their microstructure and chemical sequence distribution within the polyethylene chain. These polymers exhibit a unique microstructure and chemical sequence distribution, as determined by ¹³C NMR spectroscopy. The analysis is conducted as follows: Polymer samples are dissolved in d₂-1,1,2,2-tetrachloroethane at concentrations ranging from about 10 to 15 wt. % before being introduced into the spectrometer. Spectra are acquired using time-averaging techniques to ensure a signal-to-noise ratio sufficient for accurate measurement of the relevant signals.

The ¹³C NMR chemical shift assignments and calculations for polymer characterization are performed based on methodologies outlined in the following works: Randall, J. C. J. Polym. Sci., Polym. Phys. Ed. 1973, 11, 275-287; Randall, J. C. Polymer Sequence Determination; Academic Press: New York, 1977; Hsieh, E. T.; Randall, J. C. Macromolecules 1982, 15, 1402-1406; Randall, J. C. J. Polym. Sci., A: Polym. Chem. 1998, 36, 1527-1542; Randall, J. C.; Alamo, R. G.; Agarwal, P. D.; Ruff, C. J. Macromolecules 2003, 36, 1572-1584; Harwood, H. J.; Ritchey, W. M. J. Polym. Sci., Part B 1964, 2, 601-607; Coleman, B. D.; Fox, T. G. J. Chem. Phys. 1963, 38, 1065-1075; Kakugo, M.; Naito, Y.; Mizunuma, K.; Miyatake, T. Macromolecules 1982, 15, 150-1152; Cozewith, C. Macromolecules 1987, 20, 1237-1244.

For comparative purposes, when evaluating the copolymers produced herein against random copolymers, a Bernoullian distribution is used to model the random copolymer's sequence distribution. This method is described in K. L. Koenig's Chemical Microstructure of Polymer Chains (Robert E. Krieger Publishing Company, Florida, 1990).

¹³C NMR spectroscopic analysis provides valuable insights into the sequence distributions of monomers within copolymers. Accurate determination of triad mole fractions reveals the sequence distribution, which is closely linked to the polymer's physical properties and polymerization mechanisms. This sequence information, in particular, can shed light on the catalytic mechanism of polymer formation.

For example, if the addition of ethylene or 1-hexene occurs after the rate-determining step of the catalytic cycle, the probability of incorporating 1-hexene might not depend on the identity of the preceding monomer. In this scenario, a polymer chain ending with 1-hexene would have an equal likelihood of incorporating another 1-hexene as a chain ending with ethylene. Such polymers are referred to as Bernoullian copolymers, characterized by a single probability parameter for 1-hexene addition, independent of the last monomer unit. Bernoullian copolymers exhibit a specific random distribution of 1-hexene, with predictable diad and triad mole fractions. Conversely, block or alternating copolymers do not conform to this distribution.

However, not all random copolymers follow Bernoullian distributions. For instance, if 1-hexene is twice as likely to add to a chain ending in 1-hexene compared to one ending in ethylene, the resulting triad distribution would differ significantly. Such a polymer would show higher mole fractions of [EHH] and [HHH], deviating from Bernoullian statistics. This type of sequence distribution corresponds to a first-order Markov sequence, which is governed by two independent probability parameters. Unlike Bernoullian statistics, Markovian distributions do not imply any specific chemical mechanism.

Various parameters have been developed to quantify sequence distributions in copolymers based on monad, diad, and triad mole fractions. These include run number (or sequence number), average sequence length, persistence ratio, cluster index, average reactivity ratio product (r₁r₂), short-chain branching (butyls per 1,000 carbons), and mole percent 1-hexene (comonomer content).

For poly(ethylene-co-1-hexene) copolymers, several types of isomers can form, including: (a) Conformational/configurational isomers, and (b) Substitutional isomers. Our focus is on substitutional isomerism of the sequence type, which represents the primary structural isomers detectable by liquid-state ¹³C NMR spectroscopy. These isomers arise from the addition of either an ethylene or 1-hexene monomer unit to the growing polymer chain, where the preceding monomer could also be either ethylene or 1-hexene.

Sequences in the copolymer are commonly described using n-ads, which represent groups of consecutive monomer units: monads (single monomer units), diads (sequences of two monomer units), and triads, tetrads, and so on. For the poly(ethylene-co-1-hexene) system, the mole fractions of the two monads-ethylene (E) and 1-hexene (H)-must sum to unity:

$$[ E ] + [ H ] = 1$$

In poly(ethylene-co-1-hexene) copolymers, there are two monads (E for ethylene and H for 1-hexene), and three possible diads: EE, EH, and HH. Extending this further, six distinct triads are possible: EEE, EEH, HEH, EHE, EHH, and HHH. However, some triads are equivalent due to symmetry, for example, EEH is equivalent to HEE, and EHH is equivalent to HHE. The sum of the mole fractions of all monads, diads, or triads always equals unity. It is straightforward to see that

$$[ EEE ] + [ EEH ] + HEH = [ E ]$$

$$and$$

$$[ EHE ] + [ EHH ] + [ HHH ] = [ H ]$$

Triad concentrations are determined by spectral integration and normalized to give the mole fraction of each triad: EEE (ethylene-ethylene-ethylene), EEH (ethylene-ethylene-hexene), EHE (ethylene-hexene-ethylene), HEE (hexene-ethylene-ethylene), HEH (hexene-ethylene-hexene), and HHH (hexene-hexene-hexene). The observed triad concentrations are converted into the following diad concentrations: EE (ethylene-ethylene), HH (hexene-hexene), and EH (ethylene-hexene). The diad concentrations are determined by the following equations, where E represents ethylene monomer and H the 1-hexene comonomer.

$$[ EE ] = [ EEE ] + [ EEH ] / 2$$

$$[ HH ] = [ HHH ] + [ HHE ] / 2$$

$$[ EH ] = 2 [ EHE ] + [ HHE ]$$

The sequence number (also known as the Run Number), the average number of times the monomer switches from E to H (or H to E, but not both, according to the definition given by Randall) per 100 monomer units, can be determined in terms of triads as follows:

$$Run number = 100 ( [ EHE ] + 1 / 2 [ EHH ] ) = 1 \; 00 ( [ HEH ] + 1 / 2 [ EEH ] )$$

Mole percent 1-hexene (mole % comonomer) is determined as follows:

$$Mole Percent 1 - Hexene = 100 ( [ HHH ] + [ HHE ] + [ EHE ] )$$

Average ethylene run length is calculated by dividing the comonomer content by the run number:

$$Average Ethylene Run Length = \frac{( [ HEH ] + [ EEH ] + [ EEE ] )}{Run Number}$$

The average sequence length is the average number of monomers in an E-only or H-only monomer sequence (or “run”), and was given by Harwood and Ritchey in terms of triads as

$${n}_{E} = ( [ EEE ] + [ EEH ] + [ HEH ] ) / ( [ HEH ] + 1 / 2 [ EEH ] )$$

$${n}_{H} = ( [ EHE ] + [ EHH ] + [ HHH ] ) / ( [ EHE ] + 1 / 2 [ EHH ] )$$

The persistence ratio (ρ), was defined by Coleman and Fox as

$$ρ = \frac{2 [ E ] [ H ]}{[ E H ]}$$

The persistence ratio (ρ) provides a simple test for Bernoullian character, as ρ=1 for the Bernoullian case. A polymer exhibiting a persistence ratio greater than unity would have monomer clustering greater than expected by Bernoullian statistics.

The cluster index was defined by Randall as follows:

$$cluster index = \frac{10 ( [ H ] - [ EHE ] )}{{2 [ H ]}^{2} - {[ H ]}^{3}}$$

A cluster index of 0 would indicate that all H monomer units are separated by at least one E unit (i.e., no clustering of H), while a cluster index of 10 is consistent with Bernoullian statistics. A value greater than 10 would indicate more clustering than expected by the Bernoullian model.

The average reactivity ratio product (r₁r₂) is also a useful measure (or predictor) of sequence distribution. The parameters r₁ and r₂ represent the reactivity of monomers 1 and 2 in a copolymerization reaction. It was found that for a copolymer made by a single-site catalyst at constant comonomer concentrations, and ignoring diffusion or mixing effects, reactivity ratios can be used to relate the relative molar monomer concentration in the feedstock to the relative molar monomer concentration incorporated into the copolymer.

The average reactivity ratio product (r₁r₂) is defined on the basis of experimental diad mole fractions as follows:

$$( {r}_{1} {r}_{2} ) = 4 \frac{[ EE ] [ HH ]}{{[ EH ]}^{2}}$$

Although this definition is not model-specific, (r₁r₂) can nevertheless serve as a useful parameter, since (r₁r₂)=1 if Bernoullian or first-order Markov statistics are followed during polymerization, and single-site catalysis is involved. Significant deviations of (r₁r₂) from unity indicate that either multiple catalytic sites (with different reactivity) are involved or non-Markovian (second-order or higher-order Markovian) distributions are involved. It is typical for metallocene-catalyzed poly(ethylene-co-1-alkene) polymers to yield NMR-derived r₁r₂ values close to (or slightly less than) unity and for corresponding polymers prepared with Ziegler-Natta catalysts to yield higher r₁r₂ values.

Tables 4 and 5 present the values of various sequence distribution parameters for the polymers described in this invention and commercial LLDPE resins. By all measured parameters, the polymers of this invention (produced using a titanium-based Ziegler-Natta (ZN) prepolymer) and the ExxonMobil XP sample (produced using a hafnium-based metallocene catalyst) closely align with Bernoullian statistics. In contrast, the comparative sample produced using a conventional Ziegler-Natta catalyst (including the super hexane sample) exhibits greater deviations from the expected parameter values based on Bernoullian or first-order Markov statistics. This deviation is reflected in the average reactivity ratio product (r₁r₂), which shows a significant departure from unity for polymers produced with conventional Ziegler-Natta catalysts. This observation aligns with the known characteristics of such catalysts, which typically involve supported titanium chloride with an aluminum alkyl cocatalyst.

On the other hand, the polymer of this invention, with an r₁r₂ value near unity, demonstrates the characteristics of “single-site” Bernoullian catalysis, resulting in a sequence distribution similar to that of metallocene-catalyzed polymers. This sequence distribution imparts toughness properties, such as enhanced dart impact resistance, comparable to those observed in metallocene-catalyzed polymers.

The presence of butyl branches disrupts the crystalline packing of polyethylene chains, reducing polymer density and melting point, which enhances processability. Widely dispersed butyl branches are considered more effective in achieving these effects compared to an equal number of butyl branches clustered in close proximity.

During the polymerization of ethylene and 1-hexene, various monomer sequences can form, including ethylene-only segments, 1-hexene-only segments, and mixed sequences with both ethylene and 1-hexene units. As a result, the distribution of butyl branches within the copolymer serves as a valuable indicator of sequence distribution.

The number of butyl branches per 1,000 carbons is calculated as follows:

$$Butyls per 100 Carbons = \frac{1 - hexhene - centered troads}{6 ( 1 - hexene - centered triads ) + 2 ( ethylene - centered triads )} \times 1000$$

$$Or$$

$$Butyls per 1000 Carbons = \frac{HHH + HHE + EHE}{6 ( HHH + HHE + EHE ) + 2 ( HEH + EEH + EEE )} \times 1000$$

This metric provides insight into the microstructural arrangement of the copolymer and its resultant properties.

### Copolymer Compounding, Process and Articles Therefrom

The polymers produced according to the teachings of the present invention can be blended with various additives to form compositions suitable for use in a wide range of manufactured articles. These additives may include antioxidants, nucleating agents, acid scavengers, plasticizers, stabilizers, anticorrosion agents, blowing agents, ultraviolet light absorbers (such as chain-breaking antioxidants), quenchers, antistatic agents, slip agents, pigments, dyes, fillers, and curing agents like peroxide. Common polyolefin industry additives may be included in the compositions in amounts ranging from 0.01 to 50 wt % in one embodiment, 0.1 to 20 wt % in another, and 1 to 5 wt % in yet another embodiment, with desirable ranges defined by any combination of upper and lower weight percentage limits.

In particular, antioxidants and stabilizers, such as organic phosphites and phenolic antioxidants, may be incorporated in the polyolefin compositions. These may be present in amounts ranging from 0.001 to 5 wt % in one embodiment, 0.01 to 0.8 wt % in another, and 0.02 to 0.5 wt % in yet another embodiment. Non-limiting examples of suitable organic phosphites include: Tris(2,4-di-tert-butylphenyl) phosphite (IRGAFOS 168) and Tris(nonyl phenyl)phosphite (WESTON 399). Non-limiting examples of suitable phenolic antioxidants include: Octadecyl 3,5-di-tert-butyl-4-hydroxyhydrocinnamate (IRGANOX 1076), Pentaerythrityl tetrakis(3,5-di-tert-butyl-4-hydroxyphenyl) propionate (IRGANOX 1010), and 1,3,5-Tri(3,5-di-tert-butyl-4-hydroxybenzyl) isocyanurate (IRGANOX 3114). These additives contribute to the enhanced performance, stability, and durability of the final polyolefin compositions.

Fillers and fatty acid salts can also be incorporated into polyolefin compositions, including those based on LLDPE. The amount of filler in the composition may range from 0.1 to 65 wt % in one embodiment, 0.1 to 45 wt % in another, and 0.2 to 25 wt % in yet another embodiment.

Suitable fillers include, but are not limited to:
Metal Oxides and Carbonates: Titanium dioxide, silica (precipitated or non-precipitated), antimony oxide, zinc oxide, and calcium carbonate.
Minerals and Compounds: Silicon carbide, dolomite, barium sulfate (barytes powder), talc, hydrotalcite compounds of Mg, Ca, or Zn with Al, Cr, or Fe, and CO₃²⁻ or HPO₄²⁻ (hydrated or not).
Specialty Fillers: Carbon black, glass fibers, clays, alumina, zircon, apatite, and spinel.
Flame Retardants: Phosphorus and brominated flame retardants, antimony trioxide, and chrome-based compounds.
Other Materials: Quartz powder, magnesite, hydrochloric magnesium carbonate, silica, silicone, and blends thereof.

These fillers may also include porous materials and other filler types well-known in the art, providing flexibility in tailoring the properties of the polyolefin compositions for specific applications.

Fatty acid salts may be included in the composition in amounts ranging from 0.001 to 6 wt % in one embodiment and 0.01 to 2 wt % in another embodiment.

Examples of fatty acid metal salts include, but are not limited to:
Fatty Acids: Lauric acid, stearic acid, succinic acid, stearyl lactic acid, lactic acid, phthalic acid, benzoic acid, hydroxystearic acid, ricinoleic acid, naphthenic acid, oleic acid, palmitic acid, and erucic acid.
Metals: Lithium (Li), sodium (Na), magnesium (Mg), calcium (Ca), strontium (Sr), barium (Ba), zinc (Zn), cadmium (Cd), aluminum (Al), tin (Sn), and lead (Pb).

Preferred fatty acid salts include magnesium stearate, calcium stearate, sodium stearate, zinc stearate, calcium oleate, zinc oleate, and magnesium oleate, offering desirable properties for various applications.

In the process of blending polyolefins with one or more additives, thorough mixing is essential to ensure a uniform blend before the material is converted into a finished product. The polyolefin can be utilized in various physical forms for blending with additives. In one embodiment, reactor granules—granules of polymer directly isolated from the polymerization reactor—are used. These reactor granules may have an average diameter ranging from 10 μm to 5 mm in one embodiment and from 50 μm to 10 mm in another embodiment.

Alternatively, the polyolefin may be in the form of pellets, typically produced through the melt extrusion of reactor granules. These pellets may have an average diameter ranging from about 1 mm to 6 mm. Both reactor granules and pellets provide versatility for blending with additives, allowing for consistent and efficient processing.

One method of blending the additives with the polyolefin is to contact the components in a tumbler or other physical blending means, the polyolefin being in the form of reactor granules. This can then be followed, if desired, by melt blending in an extruder. Another method of blending the components is to melt blend the polyolefin pellets with the additives directly in an extruder, Brabender or any other melt blending means.

The resultant polyolefin resin may be further processed by any suitable means as described in prior arts: by calendaring, casting, coating, compounding, extrusion, foaming; film blowing or casting and all methods of film formation to achieve, for example, uniaxial or biaxial orientation; all forms of molding including compression molding, injection molding, blow molding, rotational molding, and transfer molding; thermoforming, as well as by lamination, pultrusion, protrusion, draw reduction, spinbonding, melt spinning, melt blowing, and other forms of fiber and nonwoven fabric formation, and combinations thereof.

The polymers produced and blends thereof are useful in such forming operations as film, sheet, and fiber extrusion and co-extrusion as well as blow molding, injection molding and rotary molding. Films include blown or cast films that are formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and nonfood contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. The molded articles include single and multi-layered constructions in the form of bottles, tanks, large hollow articles, rigid food containers and toys, etc.

### Film Extrusion and Film Properties

The polymers produced are more easily extruded into film products using cast or blown film processing techniques. They offer advantages such as lower motor load, higher throughput, and/or reduced head pressure compared to commercial alternatives, including Super-Hexene ExxonMobil NTX-095 and Nova TD-9022-D, commercial 1-octene LLDPE grades, and commercial mLLDPEs like Exceed™ resins with comparable melt index (MI), comonomer type, and density.

These polyolefin resins, for a given MI, exhibit a higher weight-average molecular weight and a narrower molecular weight distribution (MWD) than conventional Ziegler-Natta LLDPEs (ZN-LLDPEs), while maintaining a broader MWD compared to mLLDPEs. Furthermore, the resins produced through this invention have a molecular structure, including comonomer distribution across molecular weight distribution, closely resembling that of typical mLLDPE resins.

In the present invention, the film extrusion processability and performance of new LLDPE resins with novel composition distribution were evaluated using a Davis-Standard blown film pilot line. These evaluations were benchmarked against industry-leading products, including Super C6 LLDPE, C8 LLDPE, and mLLDPE resins.

The Davis-Standard blown film pilot line was operated under the following conditions: a 90-mil die gap, 2.5 blow-up ratios (BURs), 1-mil film gauge, and an output rate of 12 lbs/hr/in (equivalent to 450 lbs/hr). Film properties were tested using standard methods: Dart impact strength (g/mil) per ASTM D-1709, Elmendorf tear resistance (g/mil) per ASTM D-1922, and Secant modulus per ASTM D-882.

A Davis-Standard Cast Film Line was used to evaluate the film extrusion processability of the LLDPE cast film component layer developed in the present invention. The performance was compared against leading industrial-grade LLDPE products, including Ziegler-Natta LLDPE (ZN-LLDPE), metallocene LLDPE (mLLDPE), and C8-LLDPE.

The cast film component layer of the present invention exhibits an initial cling force value at 0% pre-stretch ranging from approximately 200 to 280 grams-force per inch width. Cling force was measured in accordance with ASTM D-5458 using a Test Resources Cling Tester integrated with an Instron 3365 Universal Tensile Tester. Cling strength was assessed at pre-stretch levels of 0%, 100%, and 200%, reflecting conditions typical of hand wrap and machine wrap applications.

### EXAMPLES

To further illustrate the preceding discussion, the following non-limiting examples are provided. While these examples pertain to specific embodiments, they are not intended to limit the scope of the invention in any specific respect.

All parts, proportions, and percentages are expressed by weight unless otherwise specified. All examples were conducted in dry, oxygen-free environments and solvents. The titanium (Ti), silicon (Si), and magnesium (Mg) content in the solid catalyst components was determined using inductively coupled plasma (ICP) emission analysis.

The melt flow index (MI) of the polymers was measured at 190° C. in accordance with ASTM D1238. The melt flow ratio (MFR), defined as the ratio of the high melt flow index (HLMI or I₂₁) to the melt index (MI or I₂), was used as an indicator of melt fluidity and molecular weight distribution (MWD). A higher MFR value corresponds to a broader molecular weight distribution.

Polymer density was measured in accordance with ASTM D1238. Unless otherwise noted, all molecular weights are reported as weight-average molecular weights (M_{w}). Molecular weights including—weight-average (M_{w}), number-average (Mₙ), and M_{z}—were determined by Gel Permeation Chromatography (GPC). The melting point of the polymers was measured using Differential Scanning Calorimetry (DSC).

The composition distribution or short-chain branching distribution, as well as the comonomer content and molecular weight in each fractionated fraction, were analyzed using Temperature Rising Elution Fractionation (TREF) and GPC-FTIR. These measurements were performed at a high temperature of 145° C., using a solvent of 1,2,4-trichlorobenzene (TCB), a flow rate of 0.9 mL/min, and a polymer solution concentration of 2.5 mg/mL.

CRYSTAF (Crystallization Analysis Fractionation) data were obtained using a commercial Model 200 instrument from PolymerChar S. A., Valencia, Spain. Approximately 30 mg of sample was dissolved in 30 mL of 1,2,4-trichlorobenzene (a chlorinated aromatic solvent). The sample was heated to 160° C. at a rate of 25° C./min under stirring and held at this temperature for 60 minutes to ensure complete dissolution. The solution was then cooled to 100° C. at the same rate (25° C./min) and equilibrated for 45 minutes. Subsequently, the polymer concentration was monitored as the solution was gradually cooled from 100° C. to 30° C. at a controlled rate of 0.9° C./min.

The properties (Tear, Dart, Secant Modulus, cling force) of film were obtained by using ASTM methods (Table 1).

TABLE 1
Definition and Testing

| | | |
|---|---|---|
| Melt Index (MI, or 12) | g/10 min. | ASTM D-1238 @190° C. |
| Density | g/cc | ASTM D-1238 |
| Dart Drop Impact | g/mil | ASTM D-1709 |
| Elmendorf Tear | g/mil | ASTM D-1922 |
| Secant Modulus (1%) | PSI | ASTM D-790A |
| Cling Force | g/inch | ASTM D-5458 |

### Catalyst Scale-Up Preparation

Anhydrous n-hexane (2200 L), iodine (3.1 kg), magnesium (1580 moles), isopropanol (14.5 moles), titanium tetra-n-propoxide (30 moles), and butyl chloride (30.0 moles) were added sequentially to a 5000 L reactor equipped with an anchor stirrer, driven by a magnetic motor rotating at 95 rpm. The reactor was heated to 85° C. until the reaction began and then cooled to 80° C.

At 80° C., tetraethoxy orthosilicate (134.5 moles) and silicon tetrachloride (419.1 moles) were added one after the other, and the reaction was held at this temperature for 60 minutes. Afterward, titanium tetra-n-propoxide (170.0 moles) and titanium tetrachloride (200.0 moles) were introduced under nitrogen, and the slurry mixture was stirred for one hour.

Next, 2,6-dimethylpyridine (200.3 moles) in a hexane solution was added, and the reaction continued at 80° C. for 2 hours, resulting in a brown/yellow reaction product, which was used without further separation.

The brown/yellow reaction solution was then directly supported with a magnesium/silicon composite, which was prepared in situ by the slow addition of n-butyl chloride (2350 moles) into the reaction product over 4 hours at 80° C. After the addition of n-butyl chloride, the mixture was stirred at 80° C. for 2 more hours and then cooled to 60° C.

The resulting precipitate was rapidly washed three times with 1200 L of hexane at 50° C.-60° C. This process yielded the catalyst as a suspension in n-hexane. The solid magnesium-based titanium catalyst component was analyzed, revealing a composition of 7.0 wt % Ti, 2.5 wt % Si, 14.5 wt % Mg, and up to 2.5 wt % nitrogen (N).

### Preparation of Titanium-Based Prepolymer

3865 gallons of n-hexane, 300 moles of tri-n-octylaluminum, and a previously prepared catalyst containing 123 moles of titanium were introduced into a 20 m³ stainless steel reactor. The reactor was maintained under a nitrogen atmosphere and equipped with an agitator rotating at 150 revolutions per minute, then heated to 70° C. Hydrogen was introduced to achieve a partial pressure of at least 0.1 MPa, and ethylene was fed at a steady flow rate of 1100 lb/h for 10 hours.

At the end of this period, the reactor was degassed, and its contents were transferred to a mechanically stirred evaporator. In the evaporator, n-hexane was removed by circulating nitrogen heated to 70° C. The resulting 11,000 lbs of prepolymer contained 50-60 g of polyethylene per millimole of titanium and was prepared for gas-phase polymerization to produce the final polymer product.

The melt index (MI or 12) of the ethylene prepolymer is approximately 1.5 g/10 min. The bulk density of the prepolymer is 0.30 g/cm³, and the particle size distribution span, defined as (D₉₀−D₁₀)/d₅₀, is 1.2. The content of particles with a size no larger than Dⁱ is 9.0% by weight. The average particle size of the prepolymer is approximately 235 μm.

### Polymer Production

Using the prepolymers described above, ethylene/1-hexene copolymer was produced according to the reaction conditions listed in Table 2.

TABLE 2
Reaction Conditions for Examples 1-7

| | Examples | | | | | | |
|---|---|---|---|---|---|---|---|
| | 1 | 2 | 3 | 4 | 5 | 6 | 7 |
| Production Rate, lb/hr | 49482 | 48890 | 39207 | 49784 | 51424 | 47275 | 50350 |
| Hydrogen/Ethylene | 0.255 | 0.235 | 0.228 | 0.217 | 0.216 | 0.298 | 0.301 |
| Ratio | | | | | | | |
| 1-Hexene/Ethylene | 0.1215 | 0.1235 | 0.1300 | 0.1203 | 0.1285 | 0.1351 | 0.1355 |
| Ratio (gas) | | | | | | | |
| Reaction temp., ° F. | 185 | 180 | 185 | 176 | 185 | 180 | 180 |
| Ethylene Partial | 100 | 110 | 95 | 100 | 115 | 100 | 105 |
| Pressure, psi | | | | | | | |
| Res. Time, hr (average) | 4 | 4 | 4 | 4 | 4 | 4 | 4 |
| Melt Index, g/10 min | 0.76 | 0.91 | 0.76 | 0.77 | 0.81 | 1.98 | 2.16 |
| Powder density, g/cc | 0.9165 | 0.9150 | 0.9145 | 0.9160 | 0.9156 | 0.9158 | 0.9161 |

The ethylene/1-hexene copolymers from Examples 1-7 were produced using the following general procedure. Polymerization took place in a commercial BP process gas-phase fluidized bed reactor, consisting of a vertical cylinder with a disengagement chamber at the top. The lower part of the reactor was equipped with a fluidization grid, and a recycling conduit connected the top of the disengagement chamber to the lower part of the reactor beneath the fluidization grid. The recycling conduit was fitted with a heat exchanger, a compressor, and feed lines for ethylene, 1-hexene, and hydrogen. Additionally, there was a feed conduit for prepolymer and a line for withdrawing the copolymer.

Polymerization was carried out at an approximate total pressure of 300 psig. The fluidizing gas passed through the bed at a velocity of around 1.8 feet per second. The gas exiting the bed entered the resin disengaging zone located at the upper portion of the reactor. From there, it was sent to the recycle loop, passing through the cycle gas compressor and a water-cooled heat exchanger. The water temperature on the shell side of the heat exchanger was adjusted to maintain the reaction temperature within the range of 175° F. to 195° F.

Ethylene, hydrogen, 1-hexene, and nitrogen were introduced into the cycle gas loop just upstream of the compressor at rates sufficient to maintain the desired gas composition. The gas composition was continuously monitored by an on-line gas chromatograph (GC) analyzer. The catalyst, in the form of prepolymer, was injected into the reactor bed via a stainless steel injection tube at a rate of 140 to 198 lbs/hr to achieve a polymer production rate of 48,000 to 55,000 lbs/hr. Nitrogen gas was used to disperse the catalyst throughout the reactor.

The polymer product was withdrawn from the reactor, collected after discharging and degassing in downstream equipment, and the gases were recycled in the loops. Residual catalyst and cocatalyst in the resin were deactivated by a wet nitrogen purge. The final polymer powder was transferred to an extrusion unit, where it was pelletized into granular form.

The granular product from Examples 1-7 was screened and dry-blended with appropriate additives for blown film and cast film applications. The additives included Irganox-1076 (available from Ciba-Geigy), IR-168, TNPP, Polybloc Talc, zinc stearate, erucamide, and DHT-4V. Pelletizing of the product was performed using a twin-screw extruder equipped with an underwater pelletizer. The output rate ranged from approximately 45,000 to 60,000 lbs/hr, with the melting temperature maintained between 221° C. and 232° C. (430° F. to 450° F.).

### Polymer Characterization

Analysis reveals that the polymers consist of two primary fractions with differing hexene contents: lower density and medium density materials (see FIG. 1 and FIG. 2). Specifically, the most soluble material elutes with a peak temperature between 25° C. and 35° C. (referred to as the 35° C. soluble fraction), while another soluble material peaks between 80° C. and 105° C. (referred to as the 35° C. insoluble fraction).

Further analysis was performed on the materials from both the 35° C. soluble and 35° C. insoluble fractions. The 35° C. soluble fraction contains the majority of the hexene and consists of the lowest density materials (i.e., those with a density below 0.890). These low-density materials represent approximately 15% to 35% of the total resin mass. In contrast, the 35° C. insoluble fraction comprises medium-density materials, accounting for 65% to 85% of the resin mass.

The GPC-FTIR results clearly indicate that the polymer composition in the invention exhibits a substantially uniform distribution of short-chain branching across its molecular weight distribution in both the 35° C. soluble and 35° C. insoluble fractions (see FIG. 3a and FIG. 3b). In both fractions, the polymer composition is homogeneous, with comonomers incorporated evenly along the high molecular weight polymer chains. There is a notable absence of low molecular weight polymer molecules. The branching distribution across the molecular weight range closely resembles that of mLLDPE. The molecular weight distribution of polymers in this invention is narrower than ZN-LLDPE but broader than mLLDPE. This structural feature is beneficial, as it allows polyethylene films to exhibit properties characteristic of both conventional ZN-made LLDPE and metallocene-made mLLDPE.

The 35° C. soluble fraction, characterized by densities below 0.890, is notable for its high molecular weight and narrow molecular weight distribution, as shown in Table 3. These low-density materials exhibit molecular weights similar to those of other fractions eluted between 35° C. and 100° C., as depicted in FIG. 4a. Unlike conventional ZN-LLDPE, super-hexene materials, and mLLDPE (e.g., EXCEED® 1018CA and Marlex® D139), each soluble fraction in this invention, when eluted across temperatures from 25° C. to 110° C., demonstrates a high molecular weight that remains consistent with one another. A comparable feature is observed in hafnium-based metallocene LLDPE (e.g., Exceed XP), although the chemical composition distribution differs (see FIGS. 4a-4d).

The polymers were analyzed using ¹³C NMR spectroscopy, and the chemical sequence and sequence distribution in the polymer microstructure are summarized in Table 4 and Table 5. It was observed that the persistence ratio (ρ) for the polymers in this invention is close to unity (ρ≈1), similar to mLLDPE but distinct from conventional ZN-LLDPE and even ZN-Super Hexene. This indicates that the sequence distribution of the polymers in this invention and mLLDPE adheres to Bernoullian statistical behavior or follows a Bernoullian model.

The cluster index for the polymers in this invention is less than 10, which aligns with mLLDPE and contrasts with conventional ZN-LLDPE and ZN-Super Hexene, where the cluster index exceeds 10. This lower cluster index demonstrates that the polymers in this invention exhibit sequence distributions consistent with Bernoullian statistics, while the higher cluster indices in ZN-LLDPE and ZN-Super Hexene suggest greater clustering than expected by the Bernoullian model.

The average reactivity ratio product (r₁r₂) serves as another useful indicator of sequence distribution. Here, r₁ and r₂ represent the reactivity ratios of monomers 1 and 2 in the copolymerization process. A value of r₁r₂₌₁ indicates Bernoullian or first-order Markovian statistical behavior and single-site catalysis. Deviations from unity suggest either the involvement of multiple catalytic sites with differing reactivities or non-Markovian (higher-order) distributions. Metallocene-catalyzed poly(ethylene-co-1-alkene) polymers typically yield r₁r₂ values near or slightly below 1, whereas polymers prepared with Ziegler-Natta catalysts often exhibit higher r₁r₂ values.

As shown in Table 5, the polymer of this invention, with an r₁r₂ value near unity, was synthesized using titanium-based ZN prepolymer. This indicates that the polymer exhibits characteristics akin to single-site Bernoullian catalysis and shares a similar sequence distribution with metallocene-catalyzed polymers. Consequently, the polymer of this invention demonstrates enhanced properties, such as improved toughness (e.g., dart impact strength), comparable to those observed in metallocene-catalyzed polymers.

TABLE 3

| | 35° C. Extraction and Analysis from CFC | | | | | | | |
|---|---|---|---|---|---|---|---|---|
| | | | | | | Comparative | Comparative | |
| | | | | Comparative | | Example 4 | Example 5 | Comparative |
| | | | | Example 2 | Comparative | (Zirconium- | (Zirconium- | Example 6 |
| | Example 1 | Example 2 | Comparative | (Super | Example 3 | based | based | (Hafnium-based |
| | (Titanium- | (Titanium- | Example 1 | Hexene: | (Super | Metallocene; | Metallocene; | Metallocene; |
| | based | based | (Conventional | ExxonMobil | Hexene: | ExxonMobil | CP Chem | ExxonMobil |
| | prepolymer) | prepolymer) | ZN Catalyst) | NTX-05) | Nova) | Exceed 1018) | D-139) | Exceed XP-8747 |
| Fraction, wt % | 16.28 | 21.28 | 14.99 | 10.22 | 12.23 | 0.65 | 0.38 | 1.54 |
| Density, g/cc | 0.885 | 0.872 | — | — | — | — | — | — |
| Mₙ | 19759 | 15803 | 2552 | 3465 | 3638 | 411 | 67 | 7112 |
| M_{w} | 104585 | 90054 | 30277 | 27788 | 31392 | 6408 | 933 | 89065 |
| M_{w}/Mₙ | 5.3 | 5.7 | 11.9 | 8.0 | 8.6 | 15.6 | 13.9 | 12.5 |

TABLE 4

| | | | | | | | Comparative | Comparative |
|---|---|---|---|---|---|---|---|---|
| | | | | | | | Example 2 | Example 6 |
| | Example 1 | Example 2 | Example 3 | Example 4 | Example 5 | Comparative | Super-Hexene | Hafnium-based |
| | Titanium- | Titanium- | Titanium- | Titanium- | Titanium- | Example 1 | (I) | Metallocene |
| | based | based | based | based | based | Z-N Catalyst | (ExxonMobil- | (ExxonMobil |
| | prepolymer | prepolymer | prepolymer | prepolymer | prepolymer | Conventional | NTX095) | Exceed-XP) |
| [EHE] | 0.0318 | 0.0330 | 0.0384 | 0.0339 | 0.0343 | 0.0318 | 0.0344 | 0.0331 |
| [EHH] + [HHE] | 0.0028 | 0.0020 | 0.0033 | 0.0005 | 0.0024 | 0.0045 | 0.0019 | 0.0020 |
| [HHH] | 0 | 0 | 0 | 0.0009 | 0 | 0 | 0.0010 | 0.0003 |
| [HEH] | 0.0053 | 0.0030 | 0.0063 | 0.0029 | 0.0046 | 0.0053 | 0.0033 | 0.0020 |
| [HEE] + [EEH] | 0.0612 | 0.0600 | 0.0706 | 0.0606 | 0.0637 | 0.0612 | 0.0658 | 0.0636 |
| [EEE] | 0.8971 | 0.9020 | 0.8815 | 0.9014 | 0.8949 | 0.8971 | 0.8946 | 0.8990 |
| [E] | 0.9636 | 0.9650 | 0.9584 | 0.9649 | 0.9632 | 0.9636 | 0.9637 | 0.9646 |
| [H] | 0.0346 | 0.0350 | 0.0417 | 0.0353 | 0.0367 | 0.0363 | 0.0373 | 0.0354 |
| [EE] | 0.9277 | 0.9320 | 0.9168 | 0.9317 | 0.9268 | 0.9277 | 0.9275 | 0.9308 |
| [HH] | 0.0014 | 0.0010 | 0.0017 | 0.0012 | 0.0012 | 0.0023 | 0.0020 | 0.0013 |
| [EH] | 0.0664 | 0.0680 | 0.0801 | 0.0683 | 0.0710 | 0.0681 | 0.0675 | 0.0682 |
| Run Number | 3.59 | 3.24 | 4.16 | 3.32 | 3.65 | 3.59 | 3.62 | 3.41 |
| 1-Hexene, mol % | 3.64 | 3.51 | 4.16 | 3.51 | 3.67 | 3.65 | 3.63 | 3.51 |
| Average Ethylene | 0.268 | 0.298 | 0.23 | 0.291 | 0.264 | 0.268 | 0.266 | 0.29 |
| Run Length | | | | | | | | |
| n_{E} (average C2 | 26.84 | 29.24 | 23.04 | 29.06 | 26.43 | 26.84 | 26.62 | 28.54 |
| sequence length) | | | | | | | | |
| n_{H} (average C6 | 0.0346 | 0.0350 | 0.0417 | 0.0353 | 0.0367 | 0.0363 | 0.0373 | 0.0354 |
| sequence length) | | | | | | | | |
| ρ (persistence ratio) | 1.004 | 0.9984 | 0.9989 | 0.9984 | 0.9985 | 1.027 | 1.065 | 1.001 |
| Cluster Index | 9.51 | 8.31 | 9.69 | 5.72 | 9.08 | 17.39 | 12.61 | 9.34 |
| r₁r₂ | 1.08 | 0.97 | 0.97 | 0.92 | 0.88 | 1.84 | 1.63 | 1.04 |
| Butyls per 1000 | 16.21 | 16.4 | 19.24 | 16.48 | 17.1 | 16.94 | 16.04 | 16.50 |
| carbons | | | | | | | | |

TABLE 5

| | Comparison of Sequence Distribution Parameters Obtained for Ethylene/1-Hexene Copolymers | | | | | | | |
|---|---|---|---|---|---|---|---|---|
| | | | | | | | | Comparative |
| | | | | | | | Comparative | Example 6 |
| | | | | | | | Example 2 | (Hafnium- |
| | | | | | | Comparative | (Super- | based |
| | | First-Order | | | | Example 1 | Hexene | Metallocene |
| | Bernoullian | Markovian | Example | Example | Example | (ZN- | ExxonMobil | (ExxonMobil |
| Parameters | Value | Value | 1 | 2 | 3 | Catalyst) | NTX-095) | Exceed XP) |
| Run Number | | | 3.59 | 3.24 | 4.16 | 3.59 | 3.62 | 3.41 |
| 1-Hexene, mol % | | | 3.64 | 3.51 | 4.16 | 3.65 | 3.63 | 3.51 |
| Average Ethylene | | | 0.268 | 0.298 | 0.23 | 0.268 | 0.266 | 0.29 |
| Run Length | | | | | | | | |
| n_{E} (average C2 | | | 26.84 | 29.24 | 23.04 | 26.84 | 26.62 | 28.54 |
| sequence length) | | | | | | | | |
| n_{H} (average C6 | | | 0.0346 | 0.035 | 0.042 | 0.036 | 0.0373 | 0.035 |
| sequence length) | | | | | | | | |
| ρ (persistence ratio) | 1 | any | 1.004 | 0.9984 | 0.999 | 1.027 | 1.065 | 1.001 |
| Cluster Index | 10 | 8.31 | 9.51 | 8.31 | 9.69 | 17.39 | 12.61 | 9.34 |
| r₁r₂ | 1 | 1 | 1.08 | 0.97 | 0.97 | 1.84 | 1.63 | 1.04 |
| Butyls per 1000 | | | 16.21 | 16.4 | 19.24 | 16.94 | 16.04 | 16.5 |
| carbons | | | | | | | | |

### Films Production and Properties

Blown films were extruded using a Davis-Standard Blown Film Pilot Line (24:1 L/D) equipped with a 6-inch oscillating die. The process conditions included a 90-mil die gap, 2.5 blow-up ratios (BUR), 1-mil film gauge, and a throughput of 12 lbs/hr/in (450 lbs/hr total). The extrusion melt temperatures for extruder zones A, B, and C were approximately 438° F., 439° F., and 435° F., respectively.

Cast films were extruded using a Davis-Standard Cast Film Line. This line consisted of a 1.25-inch diameter, 24:1 L/D KL125 Killion extruder with a general-purpose screw, a 12-inch-wide die, and a roller train. The die gap was set at 30 mils. The cast roll stack comprised two individually temperature-controlled rollers arranged in an S-wrap configuration, with an air knife used to pin the film to the rollers. The melt curtain was approximately 1 inch wide. Film drawdown was achieved by adjusting the speed of the cast roll stack. For casting operations only, a calendaring roller applied pressure to the cast sheet on the top S-wrap roller; this roller was disengaged during film production.

The film exiting the cast roll stack was directed to a master-drive nip roller and subsequently to a torque-controlled winder. A slight positive speed gradient was maintained between the nip and the cast roll stack to ensure tautness. Films were manually collected at the nip roller exit for subsequent testing.

Comparative Example 1 is LLDPE resin, a commercially conventional Ziegler-Natta catalyzed ethylene/hexene copolymer (C6-LLDPE) from Formosa Plastic Corp. Comparative Example 2 is NTX-095. a commercially available Super Strength or super hexene Z-N C6-LLDPE from ExxonMobil Chemical Company. Comparative Example 3 is TD-9022-D, a commercially available Super Strength or super hexene Z-N C6-LLDPE from Nova Chemical Company. Comparative Example 4 is EXCEED® 1018CA, a commercially available Zirconium-based metallocene C6-LLDPE from ExxonMobil Chemical Company. Comparative Example 5 is Marlex® D139, a commercially available Zirconium-based metallocene C6-LLDPE from Chevron Phillips Chemical Company. Cooperative Example 6 is EXCEED™ XP, a commercially available Hafnium-based metallocene C6-LLDPE from ExxonMobil Chemical Company. Comparative Example 7 is ExxonMobil™ LLDPE LL3002.32, a commercially available Z-N LLDPE from ExxonMobil Chemical Company. Comparative Example 8 is a commercial octene-copolymer Z-N LLDPE from Dow Chemical Company. Comparative Example 9 is EXCEED® 3518CB, a commercially available mLLDPE from ExxonMobil Chemical Company.

The blown film properties and extrusion data are shown in Table 6 and Table 7. Cast film properties and extrusion data are shown in Table 8.

TABLE 6
Blown Film Properties for Examples 1-5

| | Example | | | | |
|---|---|---|---|---|---|
| | 1 | 2 | 3 | 4 | 5 |
| MI (I₂) dg/min | 0.76 | 0.91 | 0.7 | 0.8 | 0.75 |
| HLMI (I2) | 19 | 23.7 | 18.2 | 20 | 18.8 |
| dg/min | | | | | |
| M_{w}/Mₙ | 3.6 | 3.6 | 3.5 | 3.6 | 3.6 |
| CDBI₂₅ (%) | 11.4 | 11.39 | 12.92 | 12.19 | 12.32 |
| CDBI₅₀ (%) | 20.33 | 20.93 | 24.41 | 24.52 | 26.09 |
| SDBI (° C.) | 29.09 | 28.88 | 26.79 | 23.11 | 24.56 |
| Resin Density | 0.9215 | 0.9201 | 0.916 | 0.9195 | 0.9175 |
| (g/cc) | | | | | |
| Melt Point (° C.) | 125 | 125 | 124 | 125 | 124 |
| Film Gauge | 1 | 1 | 1 | 1 | 1 |
| Target (mil) | | | | | |
| Blow UP Ratio | 2.5 | 2.5 | 2.5 | 2.5 | 2.5 |
| (BUR) | | | | | |
| Elmendorf Tear | 465 | 625 | 613 | 517 | 540 |
| MD (g/mil) | | | | | |
| Elmendorf Tear | 647 | 705 | 673 | 575 | 635 |
| TD (g/mil) | | | | | |
| MD/TD | 0.72 | 0.89 | 0.91 | 0.9 | 0.85 |
| Dart Impact | 538 | 505 | 656 | 592 | 646 |
| (g/mil) | | | | | |
| Film Haze (%) | 38 | 21 | 18 | 21 | 19 |
| Tensile @ | 5677 | 5680 | 4043 | 5431 | 5135 |
| Brk MD (psi) | | | | | |
| Tensile @ | 4989 | 4293 | 3242 | 5012 | 4627 |
| Brk TD (psi) | | | | | |
| Tensile @ | 1529 | 1656 | 1495 | 1527 | 1501 |
| Yield MD (psi) | | | | | |
| Tensile @ | 1533 | 1637 | 1502 | 1591 | 1528 |
| Yield TD (psi) | | | | | |
| Elongation @ | 672 | 703 | 640 | 651 | 648 |
| Break MD (%) | | | | | |
| Elongation @ | 884 | 870 | 750 | 782 | 745 |
| Break TD (%) | | | | | |
| 1% Secant | 18311 | 23999 | 21951 | 20889 | 21008 |
| Modulus MD | | | | | |
| (psi) | | | | | |
| 1% Secant | 18994 | 29814 | 28572 | 24531 | 25311 |
| Modulus TD | | | | | |
| (psi) | | | | | |
| Extrusion | | | | | |
| Parameters: | | | | | |
| Melt Temperature | 423 | 413 | 420 | 421 | 419 |
| (º F.) | | | | | |
| Head Pressure | 3989 | 3724 | 3741 | 3877 | 3789 |
| (psi) | | | | | |
| Die Pressure | 2425 | 2191 | 2265 | 2231 | 2198 |
| (psi) | | | | | |
| Motor Load | 64.1 | 60.3 | 63.2 | 61.5 | 62.1 |
| (amps) | | | | | |

TABLE 7
Blown Film Properties for Comparative Examples 2-6

| | Example | | | | |
|---|---|---|---|---|---|
| | 2 | 3 | 4 | 5 | 6 |
| | Super- | Super- | Exceed | CPChem | Excced- |
| | Hexene (I) | Hexene (II) | 1018 | D-139 | XP |
| MI (I₂) dg/min | 0.95 | 0.72 | 1.0 | 1.0 | 0.96 |
| HLMI (I2) dg/min | 23.75 | 20.16 | 13.95 | 17.17 | 23.9 |
| M_{w}/Mₙ | 3.8 | 4.0 | 2.7 | 2.6 | 3.2 |
| CDBI₂₅ (%) | 18.31 | 16.86 | 53.83 | 44.37 | 17.6 |
| CDBI₅₀ (%) | 28.80 | 34.40 | 64.80 | 78.18 | 35.70 |
| SDBI (° C.) | 21.90 | 21.48 | 16.06 | 11.65 | 21.50 |
| Density (g/cc) | 0.9215 | 0.9206 | 0.9180 | 0.9180 | 0.9180 |
| Melt Point (° C.) | 124 | 123 | 119 | 116 | 119 |
| Film Gauge Target (mil) | 1.0 | 1.0 | 1.0 | 1.0 | 1.0 |
| Blow UP Ratio (BUR) | 2.5 | 2.5 | 2.5 | 2.5 | 2.5 |
| Elmendorf Tear MD (g/mil) | 413 | 357 | 298 | 241 | 550 |
| Elmendorf Tear TD (g/mil) | 712 | 659 | 406 | 381 | 540 |
| MD/TD | 0.58 | 0.54 | 0.73 | 0.63 | 1.02 |
| Dart Impact (g/mil) | 293 | 409 | 513 | 633 | 680 |
| Film Haze (%) | 37 | 39 | 11 | 5 | 21 |
| Tensile @ Brk MD (psi) | 5395 | 6379 | 3587 | 3342 | 9405 |
| Tensile @ Brk TD (psi) | 4347 | 4133 | 3122 | 2439 | 7500 |
| Tensile @ Yield MD (psi) | 1388 | 1436 | 1714 | 1520 | 1395 |
| Tensile @ Yield TD (psi) | 1339 | 1392 | 1590 | 1455 | 1512 |
| Elongation @ Break MD (%) | 691 | 651 | 528 | 532 | 321 |
| Elongation @ Break TD (%) | 915 | 844 | 600 | 543 | 650 |
| 1% Secant Modulus MD (psi) | 18693 | 17500 | 21257 | 19174 | 26300 |
| 1% Secant Modulus TD (psi) | 19837 | 18266 | 21051 | 19326 | 33760 |
| Extrusion Parameters: | | | | | |
| Melt Temperature (ºF) | 420 | 423 | 433 | 428 | 415 |
| Head Pressure (psi) | 3741 | 3723 | 4123 | 3941 | 3725 |
| Die Pressure (psi) | 2265 | 2291 | 2491 | 2525 | 2380 |
| Motor Load (amps) | 63.2 | 64.3 | 70.3 | 69.2 | 63.1 |

TABLE 8
Cast Film Properties

| | | | Comparative | | |
|---|---|---|---|---|---|
| | Example | | Example | | |
| | 6 | 7 | 7 | 8 | 9 |
| MI (I₂) dg/min | 1.98 | 2.16 | 3.2 | 2.3 | 3.5 |
| Density (g/cc) | 0.917 | 0.918 | 0.918 | 0.917 | 0.918 |
| Tensile @ Brk MD (psi) | 7105 | 6380 | 5945 | 5800 | 5510 |
| Tensile @ Brk TD (psi) | 4205 | 4205 | 3335 | 4785 | 5075 |
| Elongation @ Break MD (%) | 562 | 474 | 492 | 514 | 620 |
| Elongation @ Break TD (%) | 812 | 843 | 815 | 840 | 715 |
| Stress @ Yield MD (psi) | 1450 | 1450 | 1450 | 1160 | 1160 |
| Stress @ Yield TD (psi) | 1305 | 1450 | 1160 | 1160 | 1015 |
| Elongation @ Yield MD (%) | 1885 | 2175 | 2175 | 2320 | 2175 |
| Elongation @ Yield TD (%) | 1595 | 1595 | 1595 | 1740 | 1595 |
| Puncture, low strain rate (@ 508 | 74 | 59 | 46 | 51 | 61 |
| mm/min) Energy at Break, J/mm | | | | | |
| Dart Impact (g/mil) | 190 | 180 | 85 | 185 | 211 |
| Elmendorf Tear MD (g/mil) | 477 | 465 | 633 | 461 | 299 |
| Elmendorf Tear TD (g/mil) | 561 | 581 | 759 | 539 | 511 |
| Cling Force, g/in (0% pre-stretch) | 260 | 236 | 131 | 26 | 28 |
| Cling Force, g/in (100% pre-stretch) | 212 | 211 | 75 | 31 | 25 |
| Cling Force, g/in (200% pre-stretch) | 318 | 225 | 111 | 39 | 11 |
| Film Gauge (mil) | 1.2 | 1.2 | 1.2 | 1.2 | 1.2 |
| Extrusion Parameters: | | | | | |
| Screw (rpm) | 75 | 75 | 75 | 75 | 75 |
| Stack Roll Speed (fpm) | 90 | 90 | 95 | 93 | 92 |
| Melt Temperature (º F.) | 388 | 395 | 373 | 377 | 382 |
| Barrel Zone 1 Temperature (° F.) | 350 | 350 | 350 | 348 | 351 |
| Barrel Zone 2 Temperature (° F.) | 410 | 407 | 406 | 405 | 406 |
| Barrel Zone 2 Temperature (° F.) | 419 | 415 | 415 | 415 | 414 |
| Adaptor Temperature (º F.) | 415 | 425 | 390 | 387 | 393 |
| Die Zone 1 Temperature (º F.) | 397 | 435 | 381 | 387 | 388 |
| S-Wrap Top Roll Temperature (º F.) | 105 | 105 | 105 | 105 | 105 |
| S-Wrap Bottom Roll Temperature (º F.) | 105 | 105 | 105 | 105 | 105 |

Table 6 summarizes the blown film properties of the inventive polymers, while Table 7 provides a comparison of the blown film properties for commercial ZN-LLDPE and mLLDPE polymers. Notably, the use of a titanium-based prepolymer catalyst system unexpectedly broadened the comonomer distribution, as evidenced by a reduction in the Composition Distribution Breadth Index (CDBI) and an increase in the Solubility Distribution Breadth Index (SDBI). Additionally, this catalyst system produced polymers with a narrower molecular weight distribution, as demonstrated by a decrease in the Mw/Mn ratio.

The molecular weight distribution of the inventive polymers was narrower than that of ZN-LLDPE and super-hexene LLDPE, yet broader than that of mLLDPE. Consequently, the resulting polyethylene films exhibited excellent processability, high machine-direction tear (MD tear) strength, high transverse-direction tear (TD tear) strength, superior 1% and 2% secant modulus, and exceptional dart impact resistance.

Surprisingly, the polyethylene blown films produced in the present invention demonstrated processability akin to ZN-LLDPE, with tear strength that was higher than or comparable to ZN-LLDPE and super-hexene LLDPE. Simultaneously, these films achieved dart impact strength and toughness properties equal to or exceeding those of mLLDPE. Likewise, the polyethylene cast films produced in this invention exhibited exceptional cling and stretch strength (Table 8), surpassing those of ZN-LLDPE and comparable to or on par with those of mLLDPE and octene-copolymers.

Unless otherwise specified, all numerical values for ingredient quantities, properties, reaction conditions, and other parameters provided in this specification and claims should be understood as approximate, reflecting the desired outcomes of the invention, standard measurement practices, and typical rounding conventions.

This invention is particularly well-suited to achieve the aforementioned benefits and inherent advantages. The specific embodiments disclosed are illustrative and not intended to limit the invention, which can be adapted and practiced in various equivalent ways by those skilled in the art. It should be evident that the described embodiments may be altered or modified without departing from the fundamental scope of the invention. The scope of the invention is defined by the claims that follow.

The claimed invention is:

1. A method for producing a polyethylene film, comprising:
reacting ethylene with a comonomer in the presence of a titanium-based prepolymer at temperatures ranging from about 75° C. to about 95° C., an ethylene partial pressure between about 90 psia and about 125 psia, and a comonomer-to-ethylene ratio of 0.08 to 0.15 to produce an ethylene-based polymer; and
extruding the ethylene-based polymer at conditions sufficient to produce the polyethylene film;
wherein the polyethylene film comprises a 2% secant modulus exceeding about 20,000 psi, a dart impact resistance greater than about 500 g/mil, and a machine direction (MD) tear strength greater than about 500 g/mil.

2. The method of claim 1, wherein the ethylene-based polymer is produced without additional cocatalysts or antistatic agents.

3. The method of claim 1, wherein the ethylene-based polymer is produced in a gas phase polymerization process.

4. The method of claim 1, wherein the extruding step comprises blow film extrusion.

5. The method of claim 1, wherein the extruding step comprises cast film extrusion.

6. The method of claim 1, wherein the comonomer comprises 1-hexene.

7. The method of claim 1, wherein the titanium-based prepolymer comprises particles having a particle size distribution span ((d₉₀−d₁₀)/d₅₀) of below about 1.5.

8. The method of claim 1, wherein the titanium-based prepolymer comprises a supported Ziegler-Natta catalyst precursor comprising titanium, magnesium, silicon, halogen, and a nitrogen-based electron donor.

9. The method of claim 1, wherein the titanium-based prepolymer comprises an activator or cocatalyst comprising alkylaluminum.

10. The method of claim 1, wherein the titanium-based prepolymer comprises ethylene or one or more alpha-olefins in the range of 10 g to about 500 g per mmol titanium.

11. The method of claim 8, wherein nitrogen-based electron donor is selected from pyridine, 2-methylpyridine, 4-methylpyridine, 2-ethylpyridine, 4-ethylpyridine, 4-tert-butylpyridine, 2-[methylamino]methyl]pyridine, 2,6-dimethylpyridine, 2,6-diisopropylpyridine, 2,6-di-tert-butylpyridine, 2-phenyl-6-propyl-pyridine, 2-methyl-6-phenyl-pyridine, 2, 6-trimethylsilyl-pyridine, 2,6-dimethoxypyridine, 2,6-bis(chloromethyl)-pyridine, 2,2′:6′,2′-terpyridine, 4′-(4-methylphenyl)-2,2′:6′,2″-terpyridine, and 6,6′-dimethyl-2,2′-dipyridyl.

12. The method of claim 1, wherein the ethylene-based polymer comprises a 35° C. soluble fraction comprising about 15 wt. % to about 35 wt. % of the total resin mass, with a low density below about 0.890, a molecular weight (M_{w}) greater than about 80,000), and a narrow molecular weight distribution.

13. The method of claim 1, wherein the ethylene-based polymer, when eluted across temperatures ranging from about 25° C. to about 110° C., exhibits a consistently high molecular weight across all fractions.

14. The method of claim 1, wherein the ethylene-based polymer exhibits a uniform distribution of short-chain branching across its molecular weight distribution in both the 35° C. soluble and 35° C. insoluble fractions, with an even distribution of comonomers along the polyethylene chains and a distinct absence of low molecular weight species.

15. The method of claim 1, wherein the ethylene-based polymer exhibits a chemical sequence distribution in both the 35° C. soluble and 35° C. insoluble fractions that follows Bernoullian statistics.

16. The method of claim 1, wherein the ethylene-based polymer has a Composition Distribution Breadth Index (CDBI) ranging from about 20% to about 35%, and a Solubility Distribution Breadth Index (SDBI) ranging from about 23° C. to about 30° C.

17. The method of claim 1, wherein the ethylene-based polymer has a Composition Distribution Breadth Index (CDBI) ranging from about 20% to about 30%, and a Solubility Distribution Breadth Index (SDBI) ranging from about 23° C. to about 29° C.

18. The method of claim 1, wherein the ethylene-based polymer has a molecular weight distribution (M_{w}/Mₙ) ranging from about 3.4 to about 3.8, a M_{z}/M_{w} ratio ranging from about 2.5 to about 3.8, and a melt flow ratio (MFR), defined as the ratio of I₂₁ to I₂, ranging from about 24 to about 28.

19. The method of claim 1, wherein the ethylene-based polymer has a melting point (Tₘ) ranging from about 124° C. to about 126° C. and a virgin powder density ranging from about 0.860 to about 0.930.
